(19) United States
(12) Patent Application Publication
(10) Pub. No.: US 2012/0218889 A1
(43) Pub. Date: Aug. 30, 2012

(54) HANDLING OF LOW PRIORITY DEVICES

(75) Inventors: Mahmoud WATFA, Saint Leonard (CA); Pascal M. ADJAKPLE, Great Neck, NY (US); Ulises OLVERA-HERNANDEZ, Kirkland (CA); Peter S. WANG, E. Setauket, NY (US); Kai LIU, S. Huntington, NY (US); Behrouz AGHILI, Commack, NY (US)

(73) Assignee: INTERDIGITAL PATENT HOLDINGS, INC., Wilmington, DE (US)

(21) Appl. No.: 13/401,908

(22) Filed: Feb. 22, 2012

Related U.S. Application Data
(60) Provisional application No. 61/446,253, filed on Feb. 24, 2011.
(60) Provisional application No. 61/474,446, filed on Apr. 12, 2011.
(60) Provisional application No. 61/480,725, filed on Apr. 29, 2011.
(60) Provisional application No. 61/496,318, filed on Jun. 13, 2011.
(60) Provisional application No. 61/501,422, filed on Jun. 27, 2011.
(60) Provisional application No. 61/532,829, filed on Sep. 9, 2011.
(60) Provisional application No. 61/544,986, filed on Oct. 7, 2011.
(60) Provisional application No. 61/551,658, filed on Oct. 26, 2011.

(51) Int. Cl. H04W 60/00; H04W 4/22; H04W 28/10; H04W 36/00; H04W 24/00

(52) U.S. Cl. 370/230; 370/328; 370/331; 370/252

(57) ABSTRACT

Methods, apparatus and systems for managing or handling a wireless transmit/receive unit (WTRU) are disclosed. One method includes combined registering the WTRU for a circuit switched (CS) service and a packet switched (PS) service; and the WTRU performing an independent location area update procedure to a mobile switching center (MSC)/visitor location register (VLR) responsive to: (1) the WTRU moving from a first routing area to a second routing area and (2) the WTRU running a back-off timer.

### CROSS REFERENCE TO RELATED CASES

This application claims priority from U.S. Provisional Application No. 61/446,253, filed Feb. 24, 2011, U.S. Provisional Application No. 61/474,446, filed Apr. 12, 2011, U.S. Provisional Application No. 61/480,725, filed Apr. 29, 2011, U.S. Provisional Application No. 61/496,318, filed Jun. 13, 2011, U.S. Provisional Application No. 61/501,422, filed Jun. 27, 2011, U.S. Provisional Application No. 61/532,829, filed Sep. 9, 2011, U.S. Provisional Application No. 61/544,986, filed Oct. 7, 2011, and U.S. Provisional Application No. 61/551,658, filed Oct. 26, 2011, the contents of each being incorporated herein by reference.

### BACKGROUND

Currently, back-off timers are used in certain IEEE 802.11 networks.

### SUMMARY

Methods, apparatus, and systems for managing or handling a wireless transmit/receive unit (WTRU) are disclosed. In one representative method, the WTRU is combined registered for a circuit switched (CS) service and a packet switched (PS) service and the WTRU performs an independent location area update procedure to a mobile switching center (MSC)/visitor location register (VLR) responsive to: (1) the WTRU moving from a first routing area to a second routing area and (2) the WTRU running a back-off timer.

In another representative method, the WTRU receives a paging message for a CS fallback request; operates a CS domain back-off timer; and stops the CS domain back-off timer after the CS fallback has completed or after the WTRU responds to the paging message in the CS domain.

In a further representative method, the WTRU obtains user input for selection of a closed subscriber group (CSG); and performs a standalone location area update, in response to a PS domain back-off timer running.

### BRIEF DESCRIPTION OF THE DRAWINGS

A more detailed understanding may be had from the following description, given by way of example in conjunction with the accompanying drawings. Figures in such drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a system diagram of an example communications system in which one or more disclosed embodiments may be implemented;

FIG. 2 is a system diagram of an example WTRU that may be used within the communications system illustrated in FIG. 1;

FIG. 3 is a system diagram of an example radio access network (RAN) and an example core network (CN) that may be used within the communications system illustrated in FIG. 1;

FIG. 4 is a system diagram of another example RAN and another example CN that may be used within the communications system illustrated in FIG. 1;

FIG. 5 is a diagram illustrating an interworking architecture;

FIG. 6 is a diagram illustrating a representative coverage area associated with a location area identifier;

FIG. 7 is a flowchart illustrating a representative method;

FIG. 8 is a flowchart illustrating another representative method;

FIG. 9 is a flowchart illustrating a further representative method;

FIG. 10 is a flowchart illustrating an additional representative method;

FIG. 11 is a flowchart illustrating a still other representative method;

FIG. 12 is a flowchart illustrating a still further representative method;

FIG. 13 is a flowchart illustrating a still additional representative method;

FIG. 14 is a flowchart illustrating a yet other representative method;

FIG. 15 is a flowchart illustrating a yet further representative method;

FIG. 16 is a flowchart illustrating a yet additional representative method;

FIG. 17 is a flowchart illustrating another representative method;

FIG. 18 is a flowchart illustrating a further representative method;

FIG. 19 is a flowchart illustrating an additional representative method;

FIG. 20 is a flowchart illustrating a still other representative method;

FIG. 21 is a flowchart illustrating a still further representative method;

FIG. 22 is a flowchart illustrating a still additional representative method;

FIG. 23 is a flowchart illustrating yet other representative method;

FIG. 24 is a flowchart illustrating a yet further representative method;

FIG. 25 is a flowchart illustrating a yet additional representative method;

FIG. 26 is a flowchart illustrating another representative method; and

FIG. 27 is a flowchart illustrating a further representative method.

### DETAILED DESCRIPTION

Although the representative embodiments are generally shown hereafter using wireless network architectures, any number of different network architectures may be used including networks with wired components and/or wireless components, for example.

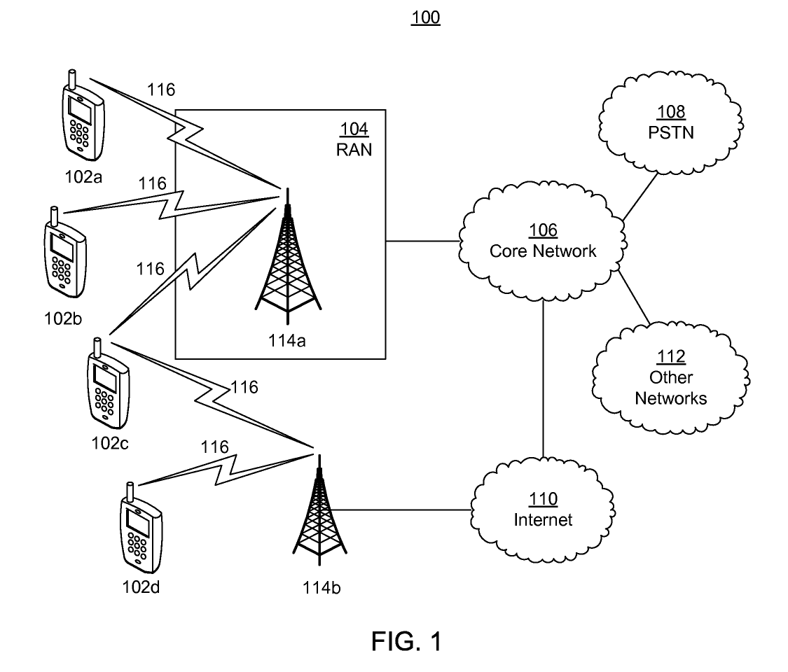

FIG. 1 is a diagram of a representative communications system 100 in which one or more disclosed embodiments may be implemented. The communications system 100 may be a multiple access system that provides content, such as, data, video, messaging, broadcast, etc., to multiple wireless users. The communications system 100 may enable multiple users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1, the communication system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communication systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communication system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunication System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communication system 100 may include multi-mode capabilities, i.e., the WTRUs 102a, 102b, 102c, 102d may include multiple transceivers for communicating with different wireless networks over different wireless links. For example, the WTRU 102c shown in FIG. 1 may be configured to communicate with the base station 114a, which may employ a cellular-based radio technology, and with the base station 114b, which may employ an IEEE 802 radio technology.

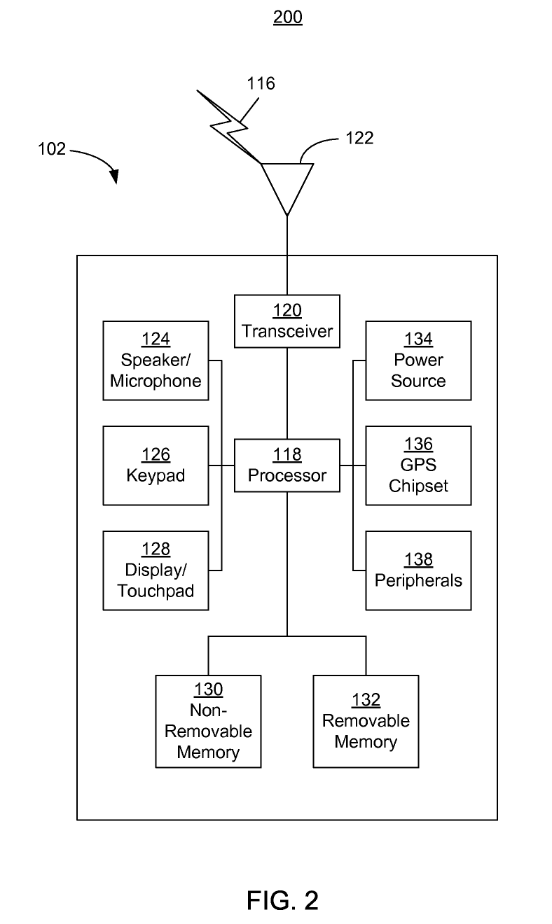

FIG. 2 is a system diagram of a representative WTRU 102. As shown in FIG. 2, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 2 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 2 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

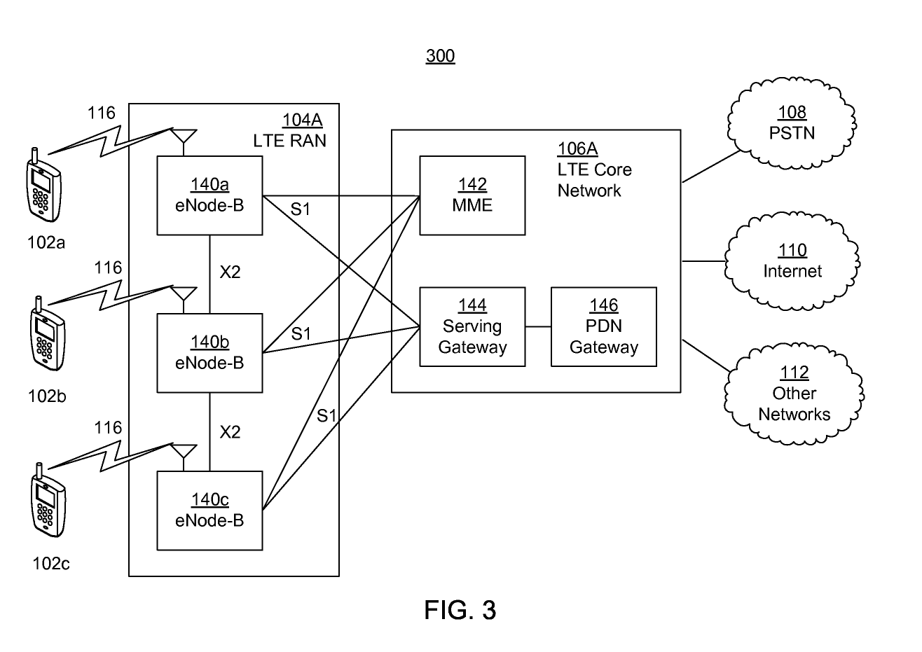

FIG. 3 is a system diagram of the RAN 104A and the core network 106A according to another embodiment. As noted above, the RAN 104A may employ an E-UTRA radio technology to communicate with the WTRUs 102a, 102b, 102c over the air interface 116. The RAN 104A may also be in communication with the core network 106A.

The RAN 104A may include eNode-Bs 140a, 140b, 140c, though it will be appreciated that the RAN 104A may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, and 140c may be associated with a particular cell (not shown) and may be configured to handle radio resource management decisions, handover decisions, scheduling of users in the uplink and/or downlink, and the like. As shown in FIG. 3, the eNode-Bs 140a, 140b, 140c may communicate with one another over an X2 interface.

The core network 106A shown in FIG. 3 may include a mobility management gateway (MME) 142, a serving gateway (SGW) 144, and a packet data network (PDN) gateway (or PGW) 146. While each of the foregoing elements is depicted as part of the core network 106A, it will be appreciated that any one of these elements may be owned and/or operated by an entity other than the core network operator.

The MME 142 may be connected to each of the eNode-Bs 140a, 140b, 140c in the RAN 104A via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104A and other RANs (not shown) that employ other radio technologies, such as GSM or WCDMA.

The serving gateway 144 may be connected to each of the eNode Bs 140a, 140b, 140c in the RAN 104A via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106A may facilitate communications with other networks. For example, the core network 106A may provide the WTRUs 102a, 102b, 102c with access to circuit-switched networks, such as the PSTN 108, to facilitate communications between the WTRUs 102a, 102b, 102c and traditional land-line communications devices. For example, the core network 106A may include, or may communicate with, an IP gateway (e.g., an IP multimedia subsystem (IMS) server) that serves as an interface between the core network 106A and the PSTN 108. In addition, the core network 106A may provide the WTRUs 102a, 102b, 102c with access to the networks 112, which may include other wired or wireless networks that are owned and/or operated by other service providers.

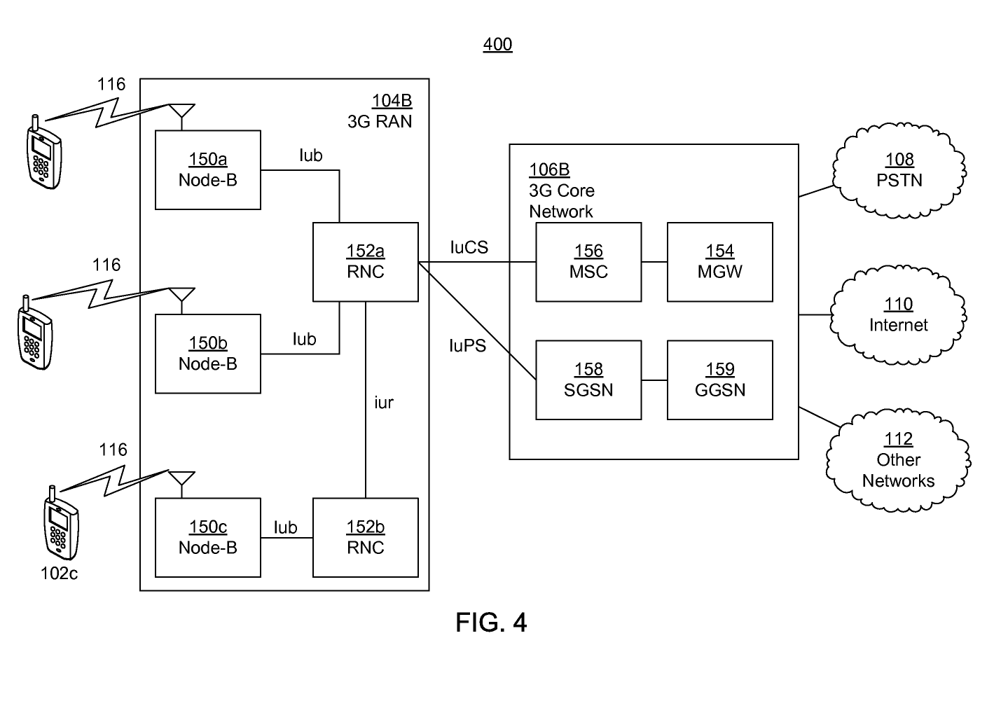

FIG. 4 is a system diagram of the RAN 104B and the core network 106B according to an embodiment. As noted above, the RAN 104B may employ a UTRA radio technology to communicate with the WTRUs 102a, 102b, 102c over the air interface 116. The RAN 104B may also be in communication with the core network 106B. As shown in FIG. 4, the RAN 104B may include Node-Bs 150a, 150b, 150c, which may each include one or more transceivers for communicating with the WTRUs 102a, 102b, 102c over the air interface 116. The Node-Bs 150a, 150b, 150c may each be associated with a particular cell (not shown) within the RAN 104B. The RAN 104B may also include RNCs 152a, 152b. It will be appreciated that the RAN 104B may include any number of Node-Bs and RNCs while remaining consistent with an embodiment.

As shown in FIG. 4, the Node-Bs 150a, 150b may be in communication with the RNC 152a. Additionally, the Node-B 150c may be in communication with the RNC 152b. The Node-Bs 150a, 150b, 150c may communicate with the respective RNCs 152a, 152b via an Iub interface. The RNCs 152a, 152b may be in communication with one another via an Iur interface. Each of the RNCs 152a, 152b may be configured to control the respective Node-Bs 150a, 150b, 150c to which it is connected. In addition, each of the RNCs 152a, 152b may be configured to carry out or support other functionality, such as outer loop power control, load control, admission control, packet scheduling, handover control, macrodiversity, security functions, data encryption, and the like.

The core network 106B shown in FIG. 4 may include a media gateway (MGW) 154, a mobile switching center (MSC) 156, a serving GPRS support node (SGSN) 158, and/or a gateway GPRS support node (GGSN) 159. While each of the foregoing elements is depicted as part of the core network 106B, it will be appreciated that any one of these elements may be owned and/or operated by an entity other than the core network operator.

The RNC 152a in the RAN 104B may be connected to the MSC 156 in the core network 106B via an IuCS interface. The MSC 156 may be connected to the MGW 154. The MSC 156 and the MGW 154 may provide the WTRUs 102a, 102b, 102c with access to circuit-switched networks, such as the PSTN 108, to facilitate communications between the WTRUs 102a, 102b, 102c and traditional land-line communications devices.

The RNC 152a in the RAN 104BA may also be connected to the SGSN 158 in the core network 106B via an IuPS interface. The SGSN 158 may be connected to the GGSN 159. The SGSN 158 and the GGSN 159 may provide the WTRUs 102a, 102b, 102c with access to packet-switched networks, such as the Internet 110, to facilitate communications between and the WTRUs 102a, 102b, 102c and IP-enabled devices.

As noted above, the core network 106B may also be connected to the networks 112, which may include other wired or wireless networks that are owned and/or operated by other service providers.

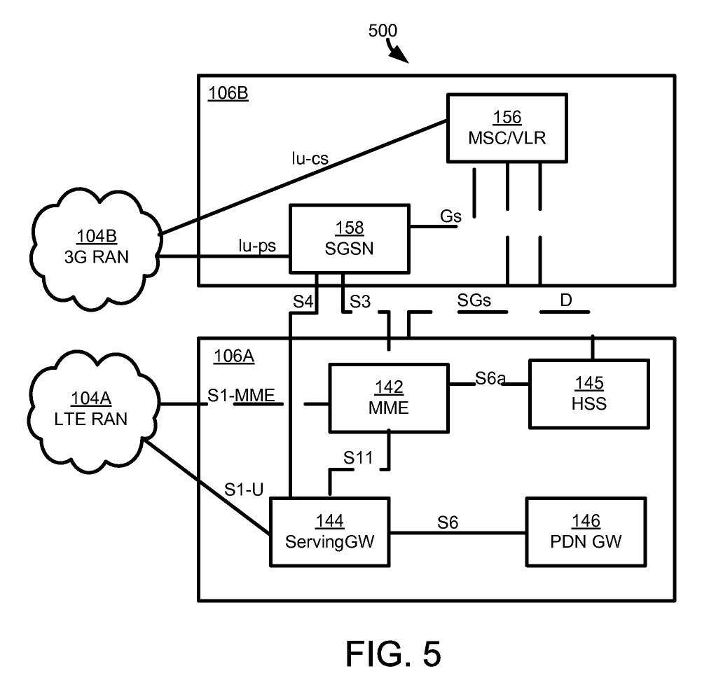

FIG. 5 is a diagram illustrating an interworking architecture 500.

Referring to FIG. 5, the interworking architecture 500 may include a CN 106A (e.g., a LTE CN) associated with a RAN 104A (e.g., a LTE RAN) and a CN 106B (e.g., a 3G CN) associated with a RAN 104B (e.g., a 3G RAN).

The CN 106A may include a MME 142, a serving gateway (S-GW) 144 a home subscriber serve (HSS) 145, and a Packet Data Network Gateway (PDN GW) 146. The S-GW 144 may interface with: (1) the PDN GW146 via an S6 interface for data plane communications (e.g., using the data plane); (2) the RAN 104A via the S1-U interface for data plane communications; (3) a Serving General Packet Radio Service (GPRS) Support Node (SGSN) 158 via the S4 interface for data plane communications; and (4) the MME 142 via an S11 interface for control plane communications (e.g., using the control plane). The MME 142 may interface with: (1) the S-GW 144 via the S11 interface for control plane communications; (2) the HSS 145 via a S6a interface for control plane communications; (3) the Mobile Switching Center/Visitor Location Register (MSC/VLR) 156 via the SGs interface for control plane communications; (4) the RAN 104A via the S1-MME interface for control plane communications; and (5) the SGSN 158 via the S3 interface for control plane communications.

The HSS 145 may interface with: (1) the MME 142 via the S6a interface for control plane communications; and (2) the MSC/VLR 156 via a D interface for control plane communications.

The CN 106B may include the MSC/VLR 156 and the SGSN 158. The MSC/VLR 156 may interface with: (1) the HSS 145 via the D interface for control plane communications; (2) the MME 142 via a SGs interface for control plane communications; (3) the SGSN 158 via the Gs interface for control plane communications; and (4) the RAN 104B via the lu-cs interface for data plane communications. The SGSN 158 may interface with: (1) the S-GW 144 via the S4 interface for data plane communications; (2) the MSC/VLR 156 via the Gs interface for control plane communications; (3) the MME 142 via the S3 interface for control plane communications; and (4) the RAN 104B via the lu-ps interface for data plane communications.

The SGs interface may be used for the mobility management and paging procedures between LTE and CS domains. The SGs interface may be a logical interface. The S6a interface enables the transfer of subscriber related data between the MME 142 and the HS 145. The S11 interface may be used to support mobility and bearer management between the MME 142 and S-GW 144. The S3 interface may enable user and bearer information exchange for inter 3GPP access network mobility in idle and/or active states.

Machine type communication (MTC) has been introduced in the third generation partnership project (3GPP) Release 10. A machine-type device may be identified by a device property in the wireless transmit/receive unit (WTRU) 102 that may indicate the device to be a low priority device. The WTRU 102 may be configured to operate as a regular device or as a low priority device and this configuration may occur using Open Mobile Alliance Device Management (OMA DM) and/or other methods. If, for example, the WTRU's 102 configuration is changed to operate as a low priority device, the WTRU 102 may indicate to the network that its device property may have changed.

A core network (e.g., the Mobility Management Entity (MME) 142, Serving General Packet Radio Service (GPRS) Support Node (SGSN), Gateway GPRS Support Node (GGSN), and/or Parallel Data Warehouse (PDW), among others) may be congested and the operator may desire to reduce the amount of signaling that may be received from the WTRUs 102. The network may choose to provide low priority devices with back-off timers, for example, to reduce the congestion because these devices are tagged or identified as low priority. During the back-off time, the low priority device may not initiate non-access stratum (NAS) procedures (e.g., except for certain events or conditions for which the low priority device may be allowed to initiate the NAS procedures). For example, if a low priority device (LPD) performs a tracking area update procedure, the network may indicate to the LPD that it is to (or should) back-off for an indicated time, which may be passed in the response message or some other communication. During the back-off time, the LPD may not start any other NAS procedure except, for example, if there is an emergency call to place or other equivalent procedures are initiated.

It is contemplated that non-LPDs (e.g., that are not configured to operate as a LPDs) may be informed or may still be informed to back-off, if the network operator desires or wants to use general congestion control. The network may apply congestion control to avoid signaling from WTRUs 102 that are tagged as low priority devices and/or WTRUs 102 that are informed to back-off.

There may be different forms of congestion control including: (1) NAS level congestion control; (2) Access Point Name (APN) level congestion control; and/or (3) core network (CN) domain congestion control, among others. The NAS level congestion control may be due to congestion in CN nodes such as the MME 142, the SGSN 158, and/or the Mobile Switching Center/Visitor Location Register (MSCNLR) 156. The APN level congestion control may be due to congestion in CN nodes such as the Packet Data Network Gateway (PDN GW) 146 and/or the GGSN, among others. There may be CN domain congestion including Packet Switched (PS) domain congestion and/or Circuit Switched (CS) domain congestion). For example, in UTRAN, the WTRU 102 with an ongoing CS call may be informed that the PS domain, (e.g., the SGSN 158), is congested when the WTRU 102 tries to establish a NAS signaling connection with the SGSN 158.

When a WTRU 102 is informed about congestion in one of the levels, the WTRU 102 may be provided with a back-off timer during which it may not initiate messaging to the CN node that is congested. If APN level congestion is detected, the WTRU 102 may not initiate session management signaling to the identified APN (e.g., during the lifetime of the back-off timer). If NAS level congestion is detected, the WTRU 102 may not initiate session management signaling to the identified CN node (e.g., MME 142, SGSN 158, and/or MSC/VLR 156, among others) (e.g., during the lifetime of the back-off timer). If CN domain congestion is detected, the WTRU 102 may not initiate signaling to the CN nodes of that domain (e.g., during the lifetime of the signaled back-off timer). As an example, exceptions may include when the WTRU 102 has an emergency call to place and/or if the WTRU 102 is paged by the network (e.g., the WTRU 102 may respond to paging if it is paged during the lifetime of the back-off timer).

A WTRU 102 in a Long Term Evolution (LTE) and/or a Universal Terrestrial Radio Access Network (UTRAN) may be requested (e.g., autonomously via the network and/or manually by user intervention) to scan for Closed Subscriber Group (CSG) cells (which may also be known as home eNodeB (HeNB) in LTE or home NodeB (HNB) in UTRAN). The WTRU 102 may display to the user a list of detected CSG cells (e.g., that may be identified by CSG IDs) from which the user may pick one for the WTRU 102 to camp on. If the selected CSG cell has a CSG ID that is not part of the WTRU's 102 list of allowed CSG cells (e.g., sometimes known as the whitelist in the Access Stratum and it may be a combination of the Operator Controlled List (OCL) and/or the Allowed CSG List (ACL) that may be maintained by the NAS), the WTRU 102 may perform a registration (e.g., tracking area update (TAU), routing area update (RAU) and/or location area update (LAU), depending on the system in question (e.g., either LTE or UTRAN) to indicate to the network that the WTRU 102 has selected the CSG cell with the CSG ID that is not included in the WTRU's 102 whitelist. The network may accept the request, (e.g., if the WTRU 102 is actually allowed on the CSG cell), or may reject the request with a cause (or cause code) to inform the WTRU 102 that the CSG cell is not allowed for access.

In the acceptance or the rejection of the request, the WTRU 102 may send a TAU, RAU, or LAU message when the CSG cell with the CSG ID not in the whitelist is selected. If the WTRU 102 is provided with a back-off timer, the WTRU 102 may not initiate any NAS procedures, (e.g., TAU, RAU, and/or LAU procedures, among others), which may impact the user experience as the device property (e.g., a LDP) may not be visible to the user and a user who is sure about the presence of a certain CSG cell may not get access on the CSG cell, for example, because the WTRU 102 may not initiate any NAS procedure due to the running back-off timer.

A PDN connection for the WTRU 102 (e.g., the establishment of the WTRU's 102 PDN connection to the network) may be related to the WTRU's 102 priority level. For example, if a WTRU 102 has a low priority and establishes a PDN connection, the low priority may, for example last for the duration of the PDN connection. If the priority changes, the PDN connection may be deactivated and a new PDN connection may be obtained.

The WTRU 102 operating in a low priority mode (e.g., as a LPD) may be combined attached for evolved packet system (EPS) and circuit switched (CS) services. If the access point node or the MME 142 is congested, the NAS procedures from the WTRU 102 may be rejected. These congestion procedures may be due to the MME 142 or the APN, (e.g., the PDN GW 146), and may not be due to the MSC and/or the VLR 156. If the WTRU 102 desires or wants to request a CS service, (e.g., circuit switched fall back (CSFB) or short message service (SMS)), the WTRU 102 may not send any related NAS signaling, for example, because it may be running the back-off timer. If the WTRU 102 performs a periodic TAU and/or the MME 142 decides to back-off the WTRU 102, the TAU may be rejected and/or a back-off timer may be included in the TAU reject message. The WTRU 102 may enter the state EMM-REGISTERED.ATTEMPTING.TO.UPDATE in which it may receive paging. The WTRU 102 may not start any NAS signaling when the back off timer is running.

For the WTRU 102 that is combined attached in LTE, (e.g., attached for EPS and SMS/CSFB), the WTRU 102 may be provided with a back-off timer, if the MME 142 is congested. While the timer is running, the WTRU 102 may not send any NAS messages to the MME 142 (e.g., the WTRU 102 may not send an SMS and/or initiate a CSFB request (e.g., because these services, which are CS-domain services, are executed through the MME 142).

The SMS may be sent over LTE NAS messages that encapsulate the SMS. The WTRU 102 may send the SMS in a NAS message that goes to the MME 142. The MME 142 may forward the SMS to the MSC/VLR 156 over the SGs interface.

A WTRU 102 may request the CSFB by sending an Extended Service Request (ESR) message (NAS) to the MME 142, which may accept or reject the request without checking with the MSC/VLR 156.

In certain representative embodiments, the MME 142 may detect or be informed about MSC/VLR 156 congestion and may reject the CSFB due to MSC/VLR 156 congestion. If the WTRU 102 sends an ESR to the MME 142 for the CSFB, the MME 142 may reject the request and may include a cause indicating that the CS domain is temporarily not available. In one case, the MME 142 may include a timer in the response message and/or the WTRU 102 may not be allowed to send the ESR (except for the CSFB for emergency calls) during the lifetime of the timer.

If the MME 142 signals NAS level congestion, the WTRU 102 may not request CSFB and/or SMS services as this may cause LTE NAS messages to be sent.

If an APN is congested, the WTRU 102 has (e.g., already has) a PDN connection established to the APN and the WTRU 102 is running a session management back-off timer, the WTRU 102 may be (e.g., may still be) allowed to perform NAS level signaling, for example a TAU procedure. The WTRU 102 may be (e.g., may still be) able to send the SMS or to perform the CSFB (e.g., because these procedures involve NAS level signaling). To send SMS messaging, the WTRU 102 if it is in idle mode, may start by sending a Service Request (SR) (e.g., for WTRUs 102 that may not be LPDs) and/or Extended Service Request (e.g., for WTRUs 102 that may be LPDs) and may use the sent message for transitioning from idle to connected mode. The procedure may establish the radio resources (e.g., user plane) associated to any active EPS bearer context (e.g. default EPS bearer and any other dedicated bearer that may have been activated). If the APN is congested, the network might not want the WTRU 102 to actually send or receive any IP data and the network might decide not to establish the radio resources as per the usual procedure response to the SR message and/or ESR message.

Not establishing any radio resources may be a failure of the SR and/or ESR procedure and the WTRU 102 may re-attach in LTE. The failure to establish radio resources in the circumstances described above may be due to congestion and not a failure of the SR and/or ESR procedure.

In certain representative embodiments, a method may be implemented to inform the WTRU 102 that radio resources are not established for the user plane due to congestion and not a failure of the SR procedure.

In certain representative embodiments, the MME 142 may be applying mobility management congestion control (and/or NAS level congestion control) for WTRUs 102 that may be provided with back-off timers and that may be prevented from sending (e.g., are not supposed to send) mobile originated (MO) data or signalling messages until the timer expires. In certain representative embodiments, for example in certain cases (e.g., certain exceptionally cases such as, if there is a request for an emergency call), the congestion control may be superseded or circumvented to allow such an emergency call. During the congestion control, the MSC/VLR 156 may request the MME 142 to page one or more WTRUs 102 that may be combined registered. The MME 142 may have provided the combined registered WTRUs 102 with back-off (or congestion control) timers, when congestion is detected, determined or experienced by the MME 142 and/or the MME 142 is informed of such congestion. The MME 142 may not desire to page the WTRUs 102 (e.g., because paging may cause an NAS message response from the WTRUs 102 and more congestion). The paging of the WTRU 102 may stop the back-off timer at the WTRU 102, for example, to allow the WTRU 102 to send mobile originated (MO) requests until further back-off notification from the network.

In certain representative embodiments, the MME 142 may implement procedures for reception of a request, for example, the MSC/VLR 156, to page the WTRU 102 that is combined registered, and that is running an NAS back-off timer.

In certain representative embodiments, procedures may be implemented to reduce or eliminate congestion, for example, CS domain congestion, when the WTRU 102 may be combined registered (CS+PS) in UTRAN or GERAN. For example, when the short message service gateway mobile switching center (SMS-GMSC) interrogates home location register (HLR)/home subscriber server (HSS) 145 for routing information, the HLR/HSS 145 may respond with the signaling address of the MSC/VLR 156, when the WTRU 102 is registered in the PS domain (e.g., SGSN 158) as well as the CS domain. When a mobile terminated (MT) short message service (SMS) message is routed to the MSC/VLR 156, there may be a failure due to MSC/VLR 156 congestion. Congestion in the CS domain may not correlate to or correspond to congestion in the PS domain.

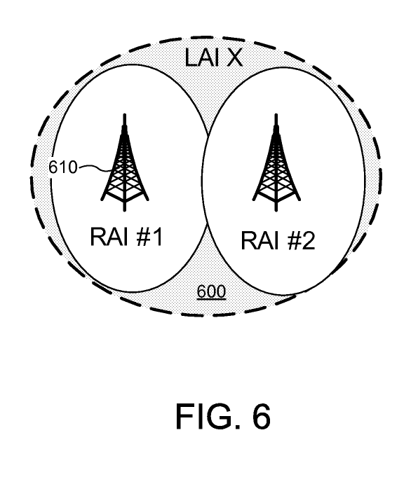

FIG. 6 is a diagram illustrating a representative coverage area 600 associated with a location area identifier.

A WTRU 102 that is combined registered and in a network that is operating in Network Mode of Operation 1 (NMOL) may miss a mobile terminated (MT) CS call as described below. For example, the location area identifier (LAI) may encapsulate at least two routing area identities (RAI), for example, as shown in FIG. 6.

Referring to FIG. 6, a plurality of towers/cells 610 (e.g., two towers/cells) with an overall coverage area 600 is shown by the dashed line. Each tower/cell 610 may broadcast the same LAI (e.g., LAI X) as the coverage of the CS service and each tower/cell 610 may broadcast a different routing area identity (RAI). For example, one cell may broadcast RAI #1 while the other cell may broadcast RAI #2. When a WTRU 102 moves, in idle mode, between these cells, it may not perform a location area update (LAU) procedure, as the same LAI is being broadcast by both cells and the WTRU 102 is in effect within the same LAI. Moving from one cell to the other may cause a change in the RAI that may be broadcast. The WTRU 102 may perform a routing area update (RAU) procedure if, for example, the WTRU 102 moves from RAI #1 to RAI #2 and RAI #2 is not in the WTRU's allowed list of RAIs.

The network may operate in different modes, one of which is NMO 1. In NMO 1, the WTRU 102 (e.g., which may know the NMO from the system information) may perform a combined procedure, (e.g., a single NAS signaling procedure to the SGSN 158 which in effect may be equivalent to a procedure to the SGSN 158 and another procedure to the MSC/VLR 156). For example, after powering on (e.g., at power on), in NM01, a WTRU 102 may perform a GPRS mobility management (GMM) attach procedure (e.g., with the “type” set to GPRS/international mobile subscriber identity (IMSI) attach) to the SGSN 158, which may perform a LAU procedure towards the MSC/VLR 156 using (e.g., over) the Gs interface, for example, to register the WTRU 102 in the CS domain as well as the PS domain. The response from the SGSN 158 may indicate that the WTRU 102 is registered to both the PS domain (e.g., SGSN 158) and the CS domain (e.g., MSC/VLR 156).

From this point onwards, the WTRU 102 may perform combined registration procedures. For example, the WTRU 102 may perform a combined RAU procedure to the SGSN 158 that may trigger the SGSN 158 to perform a location update procedure towards the MSC/VLR 156. The WTRU 102 may not perform an independent registration procedure to the PS domain (e.g., the SGSN 158 via a RAU procedure) and another registration procedure to the CS domain (e.g., the MSC/VLR 156 via a LAU procedure).

When the MSC/VLR 156 has a terminated request for the WTRU 102 that is combined registered, the MSC/VLR 156 may request the SGSN 158 to page the WTRU 102. The SGSN 158 may page the WTRU 102 in the RAI from which the WTRU 102 was last registered. The SGSN 158 may indicate to the WTRU 102 in the paging message that the CN domain, which triggered the service, is the MSC/VLR 156 (in this example) such that the WTRU 102 may know how to respond to the paging message.

When the WTRU 102 is running (e.g., operating) a GMM NAS (e.g., a PS domain) back-off timer, the back-off timer may prohibit the WTRU 102 from performing a NAS procedure (e.g., any NAS procedure) with the SGSN 158 (e.g., with the exception of emergency calls or other exceptions). If the WTRU 102 is running the GMM NAS back-off timer and is registered, for example, in RAI #1 and moves to a different cell that broadcasts RAI #2, the WTRU 102 may not perform a RAU procedure (e.g., due to the running GMM NAS back-off timer). The SGSN 158 may not know that the WTRU 102 has moved to the new area (e.g., the different cell) in idle mode. Any paging request that may come from the MSC/VLR 156: (1) may be rejected by the SGSN 158 (e.g., due to congestion at the SGSN 158); or (2) if processed by the SGSN 158, may lead to paging of the WTRU 102 in the RAI where it was last registered (RAI #1 in this example). If the SGSN 158 pages the WTRU 102 in RAI #1, the WTRU 102 may miss the paging message and the CS call.

The WTRU 102 may have different settings and/or preferences with regard to voice or data services. For example, a WTRU 102 may be data-centric, (e.g., setting is such that data services are preferred), which implies that the WTRU 102 tries to be in a system that provides PS services, while CS services are of “lower priority.” For example, a data centric WTRU 102 may choose LTE and perform combined registration for CSFB. The WTRU 102 may prefer the LTE system as its main system, but may perform CSFB when there is a CS call (and return to LTE after termination of the CS call). Similarly, a voice-centric WTRU 102 may try to remain in a system that provides voice calls. In this case, voice calls may be provided via a PS domain (e.g., IMS) or a CS domain (using legacy voice services). To use a specific domain for voice, the WTRU 102 may perform the choice based on the voice domain preference for voice services. For example, the WTRU 102 may have a voice domain selection rule set to “IMS PS voice only,” “CS voice only,” and/or “CS voice preferred and IMS PS voice as secondary,” among others. A voice-centric WTRU 102 may attempt to remain in a system where voice services are available. A WTRU 102 that is configured to operate in a voice-centric mode may perform a combined attach procedure (e.g., in LTE) such that it may have PS services and/or CS services via CSFB. If the combined attach is not successful for the CS domain and if the IMS voice is not available, the WTRU 102 may attempt to select a GERAN or UTRAN radio access technology (RAT). The WTRU 102 may disable the E-UTRAN capability. This WTRU 102 behavior, (e.g., to reselect to the CS domain for voice preference) may be due to the CS domain not being available via LTE, (e.g., CSFB may not be implemented in the LTE network). If CSFB is implemented, a voice-centric WTRU 102 may not be able to perform a combined attach (e.g., due to congestion at the MME 142 e.g., PS domain NAS congestion). The attach request (e.g., the combined attach request) may be rejected with a back-off timer and the WTRU 102 may not be allowed to initiate the mobile originated requests except, for example, for emergency services. The CS domain may not be congested (from a WTRU 102 perspective, e.g., as far as the WTRU 102 may know) and the WTRU 102 by taking no action (e.g., may remain in LTE) may not allow for the provision of voice services.

In certain representative embodiments, the WTRU 102 may have a preference to perform certain services (VOIP and/or SMS, among others using a particular domain (e.g., PS or CS domain) or type of service (e.g., SMS over IP or SMS over LTE/NAS signaling) and manual selection or CSFB may override the preference/policies of the WTRU 102.

The following embodiments may be used in any combination and apply equally to both LTE and UTRAN or any other similar systems.

It is contemplated that a WTRU 102 that runs a back-off timer may or may not be a LPD and/or low priority signaling device (LPSD).

In certain representative embodiments, the WTRU 102 (e.g., an LPD or a non-LPD) may be informed to back-off. The user may request a CSG scan and the WTRU 102 may not perform the scan during the lifetime of the back-off timer. The user may not be presented with a list of CSG cells and a selection of one of those CSG cells cannot be made.

Additionally or alternatively, the WTRU 102 may execute (e.g., still execute) a CSG cell scan upon manual CSG selection and may hold off the displaying of the found CSG IDs until the back-off timer expires. The WTRU 102 may alert the subscriber to signal the end of the back-off timer, for example, by playing a tone, vibrating, flashing the screen, and/or using any other sensing alert. It is contemplated that the end user may not be concerned about specific procedures executed by the system. A network operator may not desire or wish to inform the end user that their network is congested (e.g., which may be perceived by the end user as poor quality). An “in-progress” indication may be provided to account for the back-off time established by the back-off timer, even though the WTRU 102 has acquired (e.g., already acquired) information regarding available CSG IDs, without indicating (e.g., specifically indicating) that there is a congestion issue or that the registration could not be executed due to congestion. For example, the WTRU 102 may display available CSG IDs before (e.g., immediately or shortly before) the back-off timer expires, and may allow the end user to select a CSG ID and execute (e.g., immediately execute) the registration procedure after (e.g., just after or right after) the back-off timer expiries. By spreading the execution of the CSG selection, the WTRU 102 may provide a better user experience and may keep details of the network operation hidden from the end user.

Additionally or alternatively, the WTRU 102 may execute a CSG scan during operation of the back-off timer (e.g., even while the back-off timer is running). The end user may be presented with a list of CSG cells that belong to a different Public Land Mobile Network (PLMN) or group of PLMNs (e.g., in case of a Gateway Core Network (GWCN) RAN sharing configuration), from which the back-off timer is received. For example, if a CSG cell from a different PLMN is selected, the WTRU 102 may still perform the registration (e.g., as usual). The WTRU 102 may avoid signaling to the PLMN (or group of PLMNs in case of the GWCN RAN sharing configuration), which indicated the back-off timer. If the registration is accepted and the WTRU 102 moves and/or camps on the selected cell of the new PLMN, the WTRU 102 may keep running (e.g., still run) the back-off timer associated with the previous registered PLMN or group of PLMNs in the GWCN RAN sharing configuration with the registered PLMN. The WTRU 102 may display the CSG cells with IDs that exist in the WTRU's Operator Allowed List (OCL) and/or Allowed CSG List (ACL) and/or that belong to the PLMN from which the back-off timer is received. The WTRU 102 may not display CSG cells whose IDs are not present in the WTRU's OCL/ACL and/or that belong to the PLMN from which the back-off timer is received. This may avoid registration to the PLMN that provided the back-off timer if such a CSG is displayed and selected. The WTRU 102 may not display CSG cells that are not in the OCL or ACL, and that belong to the list of the equivalent PLMNs for the WTRU 102.

Additionally or alternatively, the end user may be presented with the list of available CSGs, belonging to all PLMNs, and the user may be notified that certain CSG cells may not be selected if they belong to the PLMN or group of PLMNs that signaled a back-off timer to the WTRU 102. This message may be provided to the end user upon presentation of a detected CSG cell.

In certain representative embodiments, the message may be presented if the selected CSG cell belongs to the network that provided the back-off timer and/or such CSG cells may be presented but grayed-out thereby not allowing the selection of such CSG cells by the end user.

Additionally or alternatively, the manual CSG cell selection may be disabled during the lifetime (e.g., duration) of the back-off timer. The user may be notified about the disabling of the CSG selection and that the CSG cells may not be displayed upon request. In certain representative embodiments, manual CSG cell selection may be disabled for the registered PLMN and may be allowed for PLMNs other than the registered PLMN or group of PLMNs in a GWCN RAN sharing configuration with the registered PLMN, if the CSGs belong to those PLMNs.

Additionally or alternatively, the manual CSG selection may be allowed and the WTRU 102 may not initiate the TAU/RAU/LAU procedure until the end of the lifetime or duration of the back-off timer. The WTRU 102 may provide an indication to the end user that processing of the request may be delayed due to network congestion. The last CSG cell selected by the end user while the back-off timer is running may be used for deciding whether to trigger the TAU procedure, the RAU procedure, and/or the LAU procedure.

In certain representative embodiments, the manual selection may be disabled after an indication to the end user that the processing of the TAU procedure, the RAU procedure, and/or the LAU procedure may be delayed or after an indication has been provided to the end user indicating network congestion. In certain representative embodiments, the CSG scanning procedure may be allowed and the CSG cell selection procedure may not be allowed.

In certain representative embodiments, the user manual CSG cell selection may be a non-machine-type-communication such that it may not be restricted by the back-off timer or timers imposed by the network for the low priority or delay tolerant applications. The particular or concerned WTRU 102 may list all CSG cells or a part of the CSG cells it has found and may operate with one or more of the following steps after the end user has selected a CSG cell that is not currently on its whitelist. The network assigned back-off timer or timers for the low priority/delay tolerant applications/procedures may continue to run. The WTRU 102 may indicate to the network that it is functioning (e.g., now functioning) as a regular (non-MTC) device. The WTRU 102 may issue the appropriate CSG manual selection action procedures, (e.g., the TAU procedure, the RAU procedure and/or the LAU procedure), without including the indication for an LPD or for a delay tolerant application/procedure, (e.g., by not including the Device Property information element (IE) or a low-priority/delay tolerant element in the Device Property IE). If the WTRU 102 is to establish a radio resource control (RRC) connection, the WTRU 102 may not include the “delay tolerant” indication in RRC message or messages for the RRC connection establishment. After the normal operations with the selected CSG cell, if the back-off timer or timers are still running, the WTRU 102 may indicate to the network that it is functioning (e.g., still functioning) as an LPD.

In certain representative embodiments, the WTRU 102 may indicate that it is an LPD and that it has temporarily modified this condition due to manual selection or any other trigger condition, such as a request for emergency services or any other condition (e.g., exceptional condition) for which the LPD condition is to be temporarily ignored or modified.

In certain representative embodiments, the WTRU 102 may be allowed to reset the back-off timer when an end user triggers manual CSG cell selection. The user manual CSG selection may be a user intervention/modification of the WTRU's mode (e.g., normal mode) of operation. If the end user selects a CSG cell that is not in the allowed CSG list, the WTRU 102 may trigger the TAU, RAU, and/or LAU procedure with a low priority bit. If the network is under a congestion condition, the network may reject the request with a new back-off timer. The WTRU 102 may indicate to the end user that the selected network is under congestion. Otherwise, if the network congestion condition has improved, the network may accept the TAU/RAU/LAU request.

In certain representative embodiments, the NAS signaling (e.g., due to manual user CSG cell selection) may be allowed, as an exception, when the back-off timer is running even though the WTRU 102 may not be allowed to initiate mobility management messages. For example, the WTRU 102 may be allowed to send a registration message (e.g., TAU/RAU/LAU) even if the back-off timer is running and/or the end user has selected a CSG cell whose CSG ID is not in the WTRUs 102 current whitelist and the CSG cell is under the same PLMN that provided the back-off timer.

If the WTRU 102 is in a UTRAN/GERAN where the WTRU 102 typically registers to both CS and PS domains, the WTRU 102 may perform a LAU when a CSG cell is manually selected and the CSG ID is not in the WTRU's list (e.g., current whitelist). This may be done, for example, if the congestion is on the PS domain (e.g., and not the CS domain). If the network is operating in a network mode of operation (e.g., NMO1), the WTRU 102 may perform a registration to the CS domain (e.g., instead of or in lieu of performing a combined registration). If the network is operating in the NMO, the WTRU 102 may perform CS domain registrations and may not perform PS domain registrations (e.g., for any reason that may have triggered (e.g., may normally have triggered) both a CS domain registration and a PS domain registration).

The WTRU 102 may perform registration to the domain that is not congested (e.g., regardless of the NMO). For example, the WTRU 102 may operate according to a different NMO than from what the network may be indicating (or broadcasting). As another example, if the WTRU 102 is running a CS back-off timer and moves to a new location area identity (LAI)/registration area identity (RAI), the WTRU 102 may perform a registration to the SGSN 158 (in PS domain) even if the NMO is a first mode (e.g., equal to NMOL).

In certain representative embodiments, deactivation procedures to deactivate the PDN connection after a priority change may be implemented and are disclosed herein.

The WTRU's priority may change and the WTRU's current PDN connection may be deactivated. The WTRU 102 may change its mode of operation from a LPD to a normal device, or vice versa and the WTRU 102 may locally deactivate its PDN connection. If the WTRU 102 is in LTE, the WTRU 102 may locally deregister (e.g., by locally entering an EMM-DEREGISTERED state), and may initiate an attach procedure. If the WTRU 102 is in UTRAN (or GERAN), the WTRU 102 may locally deactivate its PDN connection (or PDP contexts). The WTRU 102 may or may not re-attach. If the WTRU 102 does not re-attach, it may re-activate a new PDP context or PDN connection. The end user and/or applications (e.g., from higher layers) may be informed about the loss of the PDN connection.

The above representative embodiments may apply during connected mode handover (HO). For example, if the mode of operation and/or priority changes during a handover or handoff (HO), the example above may still apply after the HO. In certain representative embodiments, the WTRU 102 may not perform the HO and may first proceed with such a procedure above.

In certain representative embodiments, procedures for managing a CS service when a back-off timer is running may be implemented and are disclosed herein.

If the WTRU 102 is combined registered in LTE, and the WTRU 102 is running a back-off timer (e.g., regardless if the WTRU 102 is operating as a LPD or not) due to mobility management node congestion (e.g., MME 142 congestion), the WTRU 102 may autonomously reselect to the CS domain to place its CS service (e.g., an SMS, a CS call or another CS service, among others). For example, the autonomous reselection may occur instead of (e.g., or in lieu of) sending a request to the MME 142. The WTRU 102 may return to LTE, after the CS service is completed and/or the radio condition favors such a reselection.

If the WTRU 102 performs a TAU procedure and the network rejects the TAU due to congestion, the MME 142 may not inform the MSC/VLR 156 that the WTRU 102 is deregistered. The MSC/VLR 156 may not put the SGs state of the WTRU 102 to NULL. When the WTRU's request (any NAS request) is rejected based on a back-off timer and the WTRU 102 is combined registered, the MME 142 may not change the WTRU's SGs state to the NULL state. This may allow the WTRU's CS registration to remain active and the WTRU 102 may not be CS deregistered.

In certain representative embodiments, the WTRU 102 may be allowed to send an ESR for emergency CSFB or regular CS calls (e.g., even if the back-off timer is running in the WTRU 102). This sending of the ESR may be an exception to the condition that the WTRU 102 may not initiate NAS signaling when a back-off timer is running.

It is contemplated that the representative embodiments described herein may apply to LTE and/or UTRAN/GERAN. The embodiments may apply in any combination and may apply for any NAS message.

In certain representative embodiments, a WTRU 102 may run one or more NAS back-off timers and may have to send SMS or perform CSFB.

In LTE networks, CSFB and SMS (or certain SMS) may have a level of (e.g., some) service urgency. The handling of the WTRU 102 for network provisioning (e.g., of certain state of CN overload) such as specific APN overload/congestion and/or PS domain overload/congestion) may be specified in one or more of the following examples. If the network indicates a PS domain/specific APN overload/congestion, the WTRU 102 is combined attached for EPS and CS service modes (e.g., the WTRU 102 is EPS/IMS registered) and may perform a CSFB or has an SMS to send, the WTRU 102 may autonomously reselect to the CS domain to send the SMS or to place CS service fall back (e.g., any CS service fall back).

The reselection may be accomplished at the RRC level with a message such as UMTS InitialDirectTransfer or an UplinkDirectTransfer where the domain may be set to CS and may have one or more additional parameters indicating the service (e.g., special service of CSFB and/or SMS, among others). For example, in LTE, a parameter may be added to the RRC message “UL Information Transfer” for indicating the service urgency (e.g. the CSFB and/or the SMS (for overriding the back-off timer constraint). In certain representative embodiments, the WTRU 102 may autonomously reselect to the CS domain (e.g. UTRAN or GERAN) when there is a request to place a CS service (a CS call, a SMS, and/or supplementary services, among others); without signaling the reselection to the MME 142 (or any current serving node).

At the NAS level, a WTRU 102 may indicate in the ESR message with a parameter (e.g., new parameter) that the reason for initiating NAS signaling is due to a CS service (e.g. SMS or CSFB, among others). In certain representative embodiments, a new service type may be defined for the ESR. The WTRU 102 may be allowed to send NAS messages, on the congested system, regarding a service on a non-congested system even if the WTRU 102 is running a back-off timer for the system experiencing congestion.

If the network indicates PS domain/specific APN overload/congestion and the WTRU 102 is in Idle mode, the WTRU 102 may indicate in an RRC connection establishment cause that the reason for coming to (or changing to) connected mode is to send an SMS and/or to perform CSFB. This may be applicable for regular WTRUs 102 that may send an SR instead. The eNB 140 may forward the indication to the MME 142 identifying the processing and routing of the message (e.g., including the indicator) to the MSC 156.

A WTRU 102 that is combined registered in LTE may be running an EMM NAS back-off timer. The network may page the WTRU 102 for the CS service and the network may indicate in the paging that the WTRU 102 may stop the EMM back-off timer, which may be implemented by modifying the paging message; for example, by adding a new bit value such that a value of ‘1’ that may indicate the WTRU 102 may maintain the EMM back-off timer and a value of ‘0’ that may indicate that the WTRU 102 may stop the back-off timer (or vice versa). With this indication, the WTRU 102 may respond to the paging with the SR procedure and may or may not stop the EMM back-off timer.

The MME 142 may indicate to the RAN (HeNB and/or eNB 140) 104 that such an indication may be included in the paging message by, for example, defining a new IE in the S1AP PAGING message that may be used by the MME 142 towards the RAN 104.

In certain representative embodiments, the network may page the WTRU 102 as per existing procedures that may cause the WTRU 102 to stop the EMM back-off timer. The network may send another back-off indication (e.g., EMM back-off timer or any other back-off timer that the network desires or wishes the WTRU 102 to run and to apply) via other NAS messages (e.g., EMM Information) before the WTRU 102 is made to fallback to the CS domain. The network may use the EMM Information Request, ESM Information Request, MM Information Request, and/or GMM Information Request to indicate back-off to the WTRU 102 and to provide a back-off timer. The messages may be modified with the addition of a new IE to indicate a start or a stop of the back-off. The messages may also include back-off timers for EMM/ESM/GMM/MM or a multiple of these timers. The WTRU 102 may respond to these messages with a corresponding response (or a new NAS message) and may modify the message to acknowledge the receipt of the back-off indication/timer from the network. The network may provide the WTRU 102 with a default back-off timer (or the WTRU 102 may be configured to use a default value for a back-off timer) that the WTRU 102 may apply upon an indication from the network to back-off.

In certain representative embodiments, the network may page the WTRU 102 for CS fallback and indicate to the WTRU 102 whether it may respond to the paging (e.g., in LTE) and/or whether it may directly respond to the CS domain, which may be implemented by adding a new bit position or IE in the paging message such that one value of the bit/IE may indicate that the WTRU 102 may respond to the paging in LTE while another value may indicate that the WTRU 102 may not respond to the paging but may directly reselect to the CS domain.

These representative embodiments may be used in conjunction with other indications disclosed above (e.g., regarding stopping or not stopping of the EMM back-off timer). For example, two bit positions or IEs may be independently used as explained above with other indications represented by other bits or other IEs. In certain representative embodiments, two bit positions may represent up to four different possible states, conditions, or indications for the WTRU 102 behavior each of which may be one of the above.

In certain representative embodiments, the WTRU 102 may use the CN indication to decide on (or determine) what timer or timers may be stopped, if any timer is running. If the WTRU 102 receives a paging message, the WTRU 102 may stop the EPS mobility management (EMM) back-off timer if the CN indicator is “PS” and/or if the paging identity used is the System Architecture Evolution (SAE) temporary mobile subscriber identity (S-TMSI). The WTRU 102 may stop the CS domain back-off timer if the CN indicator is “CS”. The WTRU 102 may be allowed to respond to paging (e.g., in LTE) with a message, (for example, an emergency service reachable (ESR)), if (e.g., even if) the EMM back-off timer is running and the WTRU 102 does not stop the back-off timer.

If the WTRU 102 is paged in LTE, (e.g., with an RRC paging message or with a CS Service Notification message) for a CS fallback request and the WTRU 102 is running a CS domain NAS back-off timer (e.g., T3246), the WTRU 102 may stop the timer after the CS fallback has completed or after the WTRU 102 responds to paging in the CS domain.

If a WTRU 102 is running a CS domain NAS back-off timer, (e.g., T3246), then the WTRU 102 may not send LTE NAS messages that lead to the sending of other NAS messages to the MSC/VLR 156 except for the case of emergency services. For example, the WTRU 102 with a CS domain back-off timer may not send mobile originating (MO) request for CS fallback (e.g., by sending an ESR message) as it may lead to an inter-system change to the CS domain and ultimately the sending of CS related NAS signaling (e.g., CS SR or LAU, among others). This may be applicable if (e.g., even if) the WTRU 102 is not running a CS NAS back-off timer and the MME 142 may have been informed by the MSC/VLR 156 about congestion (e.g., in the latter). The MME 142 may send the indication to the WTRU 102, which may then stop sending MO requests for CS fallback until the congestion termination is indicated.

Alternatively or additionally, if a WTRU 102 is running a back-off timer (any back-off timer such as EMM, MM, GPRS mobility management (GMM), session management (SM) and/or APN back-off timer) and the WTRU 102 has an emergency bearer service, (e.g., may have a PDN connection for IMS, PS emergency call or may have placed a CS based emergency call), the WTRU 102 may be called back from the emergency service point. In this case, the WTRU 102 may have (e.g., may still have) a back-off timer running and may be allowed to request an emergency service, the back-off timer may not be stopped and the WTRU 102 may get paged. In this case, the WTRU 102 may not stop the back-off timer. When the WTRU 102 receives a paging message, the WTRU 102 may check whether there is an emergency PDN connection, (e.g., a PDN connection for emergency bearer services) and/or whether the WTRU 102 had requested an emergency call, (e.g., within a specified or predetermined timeframe). If an emergency PDN connection exists and/or had been requested, the WTRU 102 may not stop the timer. If an emergency PDN connection does not exist and/or had not been requested, the WTRU 102 may stop the timer.

Although specific representative embodiments are disclosed, it is contemplated that any of the above disclosed embodiments may be used in any combination.

A CN node may provide indications about congestion regarding other CN nodes. For example, the MME 142 may inform the WTRU 102 about congestion of the MSC/VLR 156 and/or the SGSN 158 if (e.g., even if) the WTRU 102 is not running a back-off timer and/or if (e.g., even if) the MME 142 is not congested. In certain representative embodiments, every time the MME 142 indicates congestion regarding the MME 142 itself or other nodes, congestion information about other CN nodes/domains, for example the MSC/VLR 156, may be provided to the WTRU 102. If congestion is indicated for another node or domain, the WTRU 102 may be provided with a separate timer for the particular CN node/domain in question. In certain representative embodiments, the WTRU 102 may apply the same timer for more than one CN node or domain. The CN nodes (e.g. MME 142, MSC/VLR 156, and/or SGSN 158, among others) may exchange congestion information that may be specific to certain WTRUs 102. For example, the MSC/VLR 156 may indicate to the MME 142 that the MSC/VLR 156 is congested via the SGs interface between the MME 142 and the MSC/VLR 156. The MSC/VLR 156 may provide the appropriate congestion timer that may be applied. The timer may be applied for a specific WTRU 102, all WTRUs 102, one IMSI, a group of devices that are represented by one IMSI, and/or a group of devices that have another common shared ID. It is contemplated that the above representative embodiments apply for any CN domain/node that may be communicating with another domain/node. If the MME 142 indicates CS domain (or MSC/VLR 156) congestion to a WTRU 102 (e.g., in LTE), the WTRU 102 may not attempt to send a SMS or perform a CSFB by way of the above described reselection to CS domain. If the CSFB is for an emergency call or the SMS reports an emergency, the WTRU 102 may be able to proceed with the described reselection to the CS domain (e.g., regardless of the particular running timer).

The WTRU 102 may be combined registered to both LTE (e.g., MME 142) and the CS domain (e.g., MSC/VLR 156) and may be running a CS domain back-off timer (e.g., T3246) while camping in LTE. The MSC/VLR 156 may then send an MT SMS message to the MME 142 for transmission to the particular WTRU 102, which may be running the CS back-off timer (e.g., T3246). In one representative embodiment, upon reception of a DOWNLINK NAS TRANSPORT message (e.g., carrying an SMS message), the WTRU 102 may stop the timer (e.g., the T3246 timer), if it is running The evolved packet system (EPS) mobility management (EMM) entity in the NAS may notify the SMS or mobility management (MM) entity in the NAS about the reception of the SMS. The SMS or MM entity may stop the timer (e.g., T3246) for the CS domain.

In certain representative embodiments, if user plane bearers are not established during an APN congestion timer lifetime, termination of SR may be implemented.

Upon transition from idle mode to connected mode (e.g., by sending a SR or ESR), the network may establish bearers in the SR. The WTRU 102 may maintain the APN back-off timer. If the network does not establish bearers in the SR, the WTRU 102 may not determine or consider this to be an abnormal case, if at least one back-off timer is running in the WTRU 102.

The network may be a collection of network nodes and links may function for different user services at various times to different populations of WTRUs 102. Depending on the time and occasion, part or the entire network segments may be overload/congested.

It is contemplated that certain parts (e.g., more often only a part or only parts) of the network may experience overload/congestions, while another part or other parts may be able to operate as normal.

The CN 106 may provide a congestion indication or a congestion start (initiation) indication for different nodes/features, for example, (1) NAS level congestion indications; (2) Access Point Name (APN) level congestion indications; and/or (3) core network (CN) domain congestion indications, among others. The NAS level congestion indicators may indicate congestion in CN nodes such as the MME 142, the SGSN 158, and/or the Mobile Switching Center/Visitor Location Register (MSC/VLR) 156. The APN level congestion indicators may indicate congestion in CN nodes such as the Packet Data Network Gateway (PDN GW) 146 and/or the GGSN, among others. There may be CN domain congestion indicators including Packet Switched (PS) domain congestion indicators and/or Circuit Switched (CS) domain congestion indicators). For example, in UTRAN, the WTRU 102 with an ongoing CS call may be informed that the PS domain, (e.g., the SGSN 158), is congested when the WTRU 102 tries to establish a NAS signaling connection with the SGSN 158.

In certain representative embodiments, the network overload or congestion indications that are sent to the RAN 104 or individual WTRUs 102 may be specific to (and/or relevant in terms of) a node and/or a functionality/service. The congestion indication may be in addition to those of the domains (PS/CS), the control plane (or c-plane), and/or the APNs that may be currently used. Likewise, the overload/congestion related back-off timer values may be specific. For example, a WTRU 102 may respect a back-off timer running towards a specific node (e.g., the service, the domain, the MME 142 and/or the APN that has been declared overload/congested with the back-off timer value). For example, the WTRU 102 may not respect a back-off timer towards other unrelated nodes, services, domains, the MME 142 and/or the APN.

For SMS transmissions and/or CSFB signaling, the network (for example, the MME 142) may send different signals/indicators to the RAN 104/WTRU 102 that the overload/congestion expressed is for SMS (related to a MSC 156) or to CSFB individually (not to mix with the MME 142 overload/congestion) in relevant messages, such as SlAP messages (e.g., for LTE) or RANAP messages (e.g., for UTRAN), TAU Request and SR and/or PDN connection messages (and their UMTS/Iu mode counterparts).

If the SMS service is overload/congested, the WTRU 102 may not be able to send an SMS (and/or a CSFB request) to the network for a period specified by the specific back-off timer, unless other SMS/CSFB supporting MSC 156 exists, and may be allowed to perform other NAS functionalities with the MME 142.

If the MME 142 is overloaded and the SMS service (or CSFB) is not overloaded, the WTRU 102 may (e.g., may still) be able to send the SMS message (or the CSFB request) provided that the congested MME 142 may route the SMS message (or the CSFB request) to the MSC 156. In certain representative embodiments, the eNB 140 may perform the SMS (or the CSFB request) delivery through another uncongested MME 142 towards the MSC. The eNB 140 may learn the SMS carriage (or the CSFB request) via some RRC indications. The WTRU 102, when sending such an SMS (or a CSFB request), may flag an indication bit in the LTE RRC messages (or their UMTS counterparts) including, for example, an Uplink Information Transfer, an RRCConnectionSetupComplete, an RRCConnectionReestablishmentComplete, and/or an RRCConnectionReconfigurationComplete.

In certain representative embodiments, the RAN may be informed about congestion in another RAT or CN domain/node that belongs to another RAT. With the congestion information, the RAN 104 may avoid handing off (HO) WTRUs 102 to these domains. For example, if LTE nodes (e.g. the MME 142 and/or the RAN via an OMA, among others) knows, is informed or determines that the UTRAN is congested, the PS HO to the UTRAN may be avoided. The RAN nodes may be provisioned with a timer during which the HO is not performed to the congested system/nodes.

In certain representative embodiments, an MME 142 may be requested by the MSC/VLR 156 to page the WTRU 102 that is running (e.g., already running) an NAS back-off timer. It is contemplated that the following representative embodiments may be applicable to any nodes that may interact with each other for the same or other procedures. For example, the MME 142 and the SGSN 158 may interact for paging a WTRU 102, or the MSC/VLR 156 and the SGSN 158 may interact (e.g., for the same purpose).

The MME 142 may check whether the particular WTRU 102 is subscribed for enhanced multimedia priority service (eMPS) or other priority services. If the WTRU 102 is subscribed, the MME 142 may choose to page the WTRU 102, if (e.g., even if) there is a congestion or if the WTRU 102 is running a back-off timer. In certain representative embodiments, the MME 142 may choose to page the WTRU 102, if the cause of the page is a specific service, (e.g., CS calls). It is contemplated that other service exceptions may be defined.

In certain representative embodiments, the MME 142 may not page the WTRU 102. The MME 142 may respond to the paging request message, (e.g., SGsAP-PAGING-REQUEST message), for example, from the MSC/VLR 156 with a paging reject message (e.g., SGsAP-PAGING-REJECT message), and may include an existing cause (SGs cause) such as “Mobile terminating CS fallback call rejected by the user” or a new cause (SGs cause) code may be defined (e.g., “NAS congestion control” or any other SGs cause with a similar functionality). Such a new cause may be used by the MSC/VLR 156 and/or the MME 142, among other nodes, (e.g., the SGSN 158 and MME 142, or SGSN 158 and MSC/VLR 156). The cause code may be used in any other procedures during which it may indicate the rejection of a request due to congestion.

Alternatively or additionally, the MME 142 may not page and may respond to the MSC/VLR 156 with a message, such as the SGsAP-UE-UNREACHABLE message, with an existing cause or a new SGs cause (e.g., as disclosed above).

In certain representative embodiments, a node that applies congestion control in general or for a particular WTRU 102 (e.g., the MME 142) may send an indication to other CN nodes (e.g., the MSC/VLR 156) to indicate the applicability of congestion to a particular WTRU 102 or set of WTRUs 102. The recipient of the indication may have the indication ahead of time (e.g., to avoid further congestion). With the indication, for example, sent towards the MSC/VLR 156, the MSC/VLR 156 may not request the MME 142 to page certain WTRUs 102 and, upon receipt of a terminating request (e.g., CS call), the MSC/VLR 156 may avoid (e.g., directly avoid) sending a paging request to the MME 142 and forward the call to another node, (e.g., voice mail) such that the MSC/VLR 156 may start or initiate a call forwarding procedure to the other node. The MSC/VLR 156 may later start sending a paging request towards the MME 142 after the MME 142 sends an indication that notifies of the termination of congestion for a particular WTRU 102 (or set of particular WTRUs 102). The indication may be in the form of a new SGs message or may be implemented with an IE as a part of an existing SGs message.

It is contemplated that the representative embodiments above may be used by any node (e.g., a MSC/VLR 156) towards another node (e.g., SGSN 158), and may not be limited to use by the MME 142 towards the MSC/VLR 156. Other nodes to which this mechanism may be applied include the MME 142 and the HSS 145.

When a WTRU-based procedure is implemented, a WTRU 102, which is combined registered, (e.g., registered in both the EPS and CS domains), and which has been informed by the MME 142 to back-off due to congestion, may monitor the paging channel in the appropriate CS radio access technology (RAT) within the stored location area identity (LAI) received during the most recent combined registration. The MME 142 may notify the MSC/VLR 156 upon the congestion (as disclosed above) and/or may inform the MSC/VLR 156 with a paging reject message, such as a SGsAP-PAGING-REJECT, or a message, such as the SGsAP-UE-UNREACHABLE. When the WTRU 102 supports both GERAN and UTRAN, an indicator/parameter “Preferred RAT for MT CSFB under congestion” may be communicated between the MME 142 and the WTRU 102. The indicator/parameter may be sent by the MME 142 to the WTRU 102 along with the LAI in the ATTACH/TAU Accept message.

In certain representative embodiments, the MME 142, the MSC/VLR 156 and/or any other node, which applies back-off for the WTRU 102 (e.g., provides the WTRU 102 with a back-off timer), or which may be informed about the WTRU 102 being backed off, may use or set a flag for the WTRU 102 in question to indicate whether the WTRU 102 is backed-off or not. For example, when the MME 142 provides a back-off timer to the WTRU 102, the MME 142 may generate or create a “back-off flag” and may set the back-off flag value to true. When the back-off is terminated, the MME 142 may change the value of the flag to false. This procedure may apply to other nodes in the system, (e.g., the MSC/VLR 156, the HSS 145, the SGSN 158, and/or the SGW, among others).

A CN node may store another flag that may indicate if other CN nodes are applying back-off timers for a WTRU 102 or set of WTRUs 102. For example, the MME 142 may keep or maintain a flag to indicate that the MME 142 is applying a back-off timer for a particular WTRU 102, and the MSC/VLR 156, if notified about the back-off timer by an MME 142 for a particular WTRU 102 (or set of WTRUs 102), may have a flag to indicate that the WTRU 102 (or set of WTRUs 102) are being backed off by a particular MME 142 whose address may be saved along with the PLMN identity.

If a node (e.g., the MSC/VLR 156) receives an incoming request for a WTRU 102, the MSC/VLR 156 may check if the WTRU 102 has been backed off in a particular domain (e.g., an MME 142 indicated back-off for the WTRU 102 and MSC/VLR 156 may have such a flag). The MSC/VLR 156 based on the flag, may not forward a request to a CN node (e.g., the MME 142) that has indicated back-off for the WTRU 102. The MSC/VLR 156 may not forward the mobile terminated service to the MME 142 that has indicated back-off for the WTRU 102. The MSC/VLR 156 may take other actions, for example, paging the WTRU 102 in the CS domain and/or requesting other CN nodes, (e.g., the SGSN 158), to page the WTRU 102.

If a WTRU 102 is running back-off timers for several CN domains, for example, a. back-off timer for the PS domain in LTE and a back-off timer for CS domain (and the WTRU 102 is in LTE where the WTRU 102 has performed a combined attached for EPS and CS services), and the WTRU 102 gets paged, the WTRU 102 may verify the CN domain of the paging message and may stop a corresponding timer (e.g., any corresponding timer), if running If the WTRU 102 is paged for the CSFB and the CN domain indicates ‘CS’, the WTRU 102 may stop the back-off timer for the CS domain and may respond to paging (e.g., even though the response to paging may be performed using LTE NAS signaling). It is contemplated that the WTRU 102 may be informed (e.g., in connected mode) that there is a terminating CS call via the use of a dedicated NAS message (e.g., a CS Service Notification). The WTRU 102 may not be paged as the WTRU 102 is in connected mode. For this case, the representative embodiments described above may also be applied. For example, if WTRU 102 receives CS Service Notification for a mobile terminated (MT) CSFB, the WTRU 102 may stop a CS related back-off timer (e.g., any CS related back-off timer) and may respond, accordingly.

The WTRU 102 may not stop the back-off timer for the LTE PS domain or LTE general NAS congestion control back-off timer, if running In certain representative embodiments, the WTRU 102 may stop the LTE back-off timers, if (e.g., even if) the CN domain that triggered the paging is the CS domain. It is contemplated that the above procedures may also apply to UTRAN/GERAN when the WTRU 102 is also registered on both the CS domain and PS domain.

In certain representative embodiments, procedures may be implemented for providing SMS transfer over the PS domain in case of congestion in the CS domain.

If the WTRU 102 is combined (CS+PS) attached, a Gs interface may exist between the MSC/VLR 156 and the SGSN 158. In certain representative embodiments, when the MSC/VLR 156 receives the SMS message, it may send the SMS message to the SGSN 158 (e.g., instead of paging the WTRU 102 in the CS domain). This procedure may be implemented by introducing a message (e.g., a new message) over the Gs interface or modifying one of the existing messages. Upon reception of the information (e.g., from the MSC/VLR 156), the SGSN 158 may start paging the WTRU 102 and may bring the WTRU 102 to a connected mode (e.g., to deliver the SMS message).

In certain representative embodiments, the procedures may be handled in the CS core network side. For example, the VLR may send an RP-ERROR back to the SMS service center (SMS-SC) and may inform the HLR about the failure along with information that the HLR may use the SGSN signaling address for the next (e.g., follow-up) interrogation. Using this mechanism, the HLR may use the conventional “Alert SC” procedure and may reply with the SGSN address when requested (or asked) by the SMS-GMSC for routing information.

In certain representative embodiments, a CN node or nodes (e.g., the MSC/VLR 156, the SGSN 158 and/or the MME 142, among others) may indicate to the HLR/HSS 145 if the CN nodes (e.g., the MSC/VLR 156, the SGSN 158, and/or the MME 142, among others) are applying or terminating congestion control for some WTRUs 102 (e.g., a subset of WTRUs 102), all WTRUs 102 or one or more specific WTRUs 102. When the HSS 145 receives an indication about the starting or terminating of congestion control for the WTRUs 102 (some WTRUs 102, all WTRUs 102 or specific WTRUs 102), the HLR/HSS 145 may save the indication (e.g., in the form of a flag), so that it may stop (or may start in case of congestion termination) certain requests sent directly or eventually towards these nodes (e.g., MT SMS transfer and interrogation from the SMS-SC). For example, if the HLR/HSS 145 receives an indication about the start of congestion control for one or more WTRUs 102, the HLR/HSS 145 may inform other nodes (e.g., the SMS-SC) that certain services may be forwarded via other nodes (e.g., the MSC/VLR 156 may indicate congestion to the HLR/HSS 145, which may inform the SMS-SC to route service and/or data via the SGSN 158). The HLR/HSS 145 may provide the indication to the SMS-SC when the congestion status changes or upon request form the SMS-SC (e.g., due to a MT service). Such an indication from the HLR/HSS 145 may be provided to other nodes. The MSC/VLR 156 and/or the SGSN 158/MME 142 may directly provide the indications to other servers (e.g., an SMS-SC and/or a server for location services, among others).

In a legacy networks such as a GERAN and/or a UTRAN where the WTRU 102 may be attached to both CS and PS domains, the WTRU 102 may try to send MO SMS traffic over the CS domain. In certain representative embodiments, the WTRU 102 may try the other domain, (e.g., the PS domain) when the MSC/VLR 156 returns a congestion indication, or when the MSC/VLR 156 returns an ERROR message for the SMS request (CP-DATA) from the WTRU 102 without (e.g., even without) an indication (e.g., any indication) of congestion. In such representative embodiments, the WTRU 102 may try to send the SMS message over the domain that is not indicated congested.

Representative embodiments for triggering for a WTRU 102 to perform registration (e.g., LAU) are disclosed hereafter.

In certain representative embodiments, if a WTRU 102 moves from one RAI to another such that a routing area update (RAU) procedure is to be initiated and the WTRU 102 is running (e.g., operating) a PS domain NAS back-off timer (e.g., T3346), the WTRU 102 may perform an independent/standalone location area update (LAU) procedure to the MSC/VLR 156 (e.g., even if the NMO may be 1). The LAU procedure may be performed when the WTRU 102 moves between two routing areas within the same location area.

If the LAU procedure is not performed, although the WTRU 102 is within the same location area, because the WTRU 102 has changed to another routing area and the SGSN 158 may page the WTRU 102 over or in the previous routing area, the WTRU 102 may not be able to decode the paging message. Due to the operation of a PS domain NAS back-off timer, the WTRU 102 may not be allowed to perform an RAU procedure and inform the SGSN 158 about its new location.

Performing a standalone location update may allow the MSC/VLR 156 to break the Gs association with the SGSN 158 for the WTRU 102 and may allow the MSC/VLR 156 to page (e.g., directly page) the WTRU 102 when a mobile-terminated service arrives. The MSC/VLR 156 may not page the WTRU 102 via the SGSN 158 as expected for NMO 1. The WTRU 102 may also indicate in the LAU that the SGSN 158 is congested. The congestion indication may be in any form and the WTRU 102 may include PS domain related parameters to identify the SGSN 158. The MSC/VLR 156 may start paging other WTRUs 102 (e.g., directly without going to the SGSN 158) or in parallel with the Gs paging. For example, the WTRU 102 may report to one node that the WTRU 102 is running a back-off timer for another node (e.g., if the WTRU 102 is communicating with the MME 142, the WTRU 102 may report MSC/VLR 156 congestion, if the WTRU is running a back-off timer for the CS domain).

In certain representative embodiments, a particular node (e.g., a WTRU 102 and/or a network node, among others) may report congestion indicators or overload indicators regarding network resources to any node in communication with the particular node. In certain representative embodiments, the WTRU 102 may report SGSN or MME congestion when the WTRU 102 communicates to the MSC/VLR 156. In certain representative embodiments, the WTRU 102 may report RAN congestion related to one or more RAT and/or the WTRU 102 may report CN/RAN congestion when the WTRU 102 is in communication with a specific RAN 104.

In certain representative embodiments, if the SGSN 158 receives a request to page a WTRU 102 (e.g., any WTRU) and the SGSN 158 is congested and/or applying congestion for any WTRU 102 (or the particular WTRU 102 associated with the request, e.g., for which the request is to come), the SGSN 158 may send a new or conventional base station system application part (BSSAP) message (e.g., the protocol used on the Gs interface) to inform the MSC/VLR 156 about the congestion for that WTRU 102 and/or other WTRUs 102. The MSC/VLR 156 may choose to page the WTRU 102 (e.g., directly) in the LAI where the WTRU 102 was last registered.

If an attach request of the WTRU 102 is rejected or a NAS registration message (e.g., any NAS registration message such as a TAU message) is rejected (e.g., due to back-off), the WTRU 102 may reselect to the CS domain if any of the following conditions exists: (1) the WTRU 102 is voice-centric; 92) the WTRU 102 supports GERAN, UTRAN, CDMA RAT, and/or a CS domain; (3) the IMS is not supported by the WTRU 102; (4) IMS voice is not supported by the WTRU 102; (5) the network has indicated or indicates that IMS is not supported; (6) the WTRU 102 prefers CS domain for voice calls; (7) the WTRU 102 prefers IMS domain for voice calls or prefers CS domain as a secondary for voice calls; and/or (8) the WTRU 102 is not configured to use IMS or IMS for voice calls.

The reselection to the CS domain may be done following a local (e.g., autonomous) change of the WTRU 102 settings such that the CS domain may get a priority. For example, the WTRU 102 may deactivate the E-UTRA capability. In certain representative embodiments, the WTRU 102 may keep the E-UTRA capability active and the setting may be changed such that the CS domain may be prioritized for voice call. The WTRU 102 may apply the CS domain reselection in accordance with the above representative embodiments (e.g., until a timer may be stopped and/or expires). In certain representative embodiments, the WTRU 102 may revert back to LTE and/or the original settings if there is an emergency call to place (e.g., in the PS domain), for example, when the WTRU 102 moved from LTE to GERAN (e.g., without being able to find a UTRAN cell (e.g., any UTRAN cell). The WTRU 102 may display an indication to the user to indicate that the PS domain is congested. The user may change the WTRU 102 settings such that the CS domain is selected. In certain representative embodiments, the user may be displayed with actions (e.g., possible actions) that the WTRU 102 may take, (for example, the user's input may be requested to select to the CS domain).

If a WTRU's combined attach request is accepted for EPS (e.g., just for EPS) and a back-off timer is presented for the CS domain, the WTRU 102 (e.g., even thought not yet registered to the CS domain) may send an ESR to the MME 142 (and/or another equivalent entity) to indicate that a CSFB call (e.g., the CSFB for an emergency) is imminent.

In certain representative embodiments, the ESR message may include a new information element or a new code-point for one of the conventional information elements, (e.g., a Service Type), for the MME 142 to be notified so as not to reject the ESR. The MME 142 may accept the request and may inform the eNB 140 to execute the CSFB procedure (e.g., via an RRC release with redirection information). This procedure may apply if (e.g., even if) the WTRU 102 is not backed off and has not performed a combined registration.

During the RRC connection establishment, a LPD may set an establishment cause to “delay tolerant.” The node that processes the request may reject the establishment (e.g., due to the device being a LPD). When a device is in connected mode (e.g., already in a connected mode), during the handover of the device to a target cell (e.g., the target node), the device may not indicate that it is a LPD to the target cell. If the target cell desires (or wants) to release the connection of LPDs (e.g., due to load conditions or other conditions), the target cell may not have this information (e.g., as the WTRU 102 may already be in a connected mode).

In certain representative embodiments, a source node (e.g., a source ReNB, eNB, RNB or NB, among others) may forward a device property (or several device properties, if applicable) as received during the establishment of an RRC connection (or from a previous source node) to the target node (e.g., a target ReNB, eNB, RNB or NB, among others) during the handover (e.g., regardless of whether the handover is via the CN or is executed directly between the source and the target nodes). The target node may use this information to release the connection of certain WTRUs 102 or for load balancing in case of (or when) receiving several subsequent connection requests from other (e.g., normal priority) WTRUs 102. The device property may be the “delay tolerant” indicator or any other property, subcategory, or feature that may be defined for WTRUs 102. For example, other properties may be “small data transmission,” and/or “MO only,” among others. The source node may forward more than one property to the target node based on a condition or state (e.g., if this information is available). The CN may forward the information to the target node during the handover or after the handover is completed. The WTRU 102 may forward one or more device properties to the target node at or after the handover (e.g., via existing or new RRC messages). If the device properties are to be provided by the source node, the device property indication may be enabled by setting the QoS characteristics of the bearers of the WTRU 102 to specific values (and/or QoS parameters that may be exchanged between the source node and the target node). In certain representative embodiments, a new QoS class identifier (QCI) range may be defined for LPD bearers (and/or bearers below any other special class of devices). For example, values from 10 to 18, 32 to 40, or 247 to 255, among any other range may be assigned to the QCI of bearers that belong to LPDs.

In certain representative embodiments, the presence of a bearer with a QCI value different from the QCI values defined for bearers associated with non-LPDs may be interpreted as the corresponding device is or may be a LPD. Such a QCI value may be assigned to any specific bearer to signal that a device is a LPD.

In certain representative embodiments, a new range of values of the standardized characteristics (e.g., priority, packet delay budget, packet error loss, and/or resource type, among others) associated with the standardized QCI values, may be defined for LPD bearers. For example, two priority values may be defined for a given QCI (e.g., any given QCI) or all QCIs. For example, QCI value 1 may be associated with priority values 2 and 10. Priority value 2 may be a standardized priority value for bearer with QCI value 1. For example, priority value 10 for QCI value 1 may indicate that the corresponding device is a LPD. This may not be applicable to specific devices that belong to a specific access class or if the device is a priority device (as indicated by the WTRU 102 or the CN to the RAN 104). The source node may provide the indication via a new or conventional information element.

The above representative embodiments may be applied for handover to and from the GERAN. For example, for the handover from the GERAN to the UTRAN or EUTRAN, the device property may be signaled to the GERAN base station system (ESS), during the radio resource connection establishment, (i.e., in the Channel Request Message) and/or later upon establishment of the layer 2 signaling (LAPDm and/or RLC/MAC). In the first case, a new “establishment cause,” alone or in combination with a random number, may be used. For the latter case, spare bits in the header may be used.

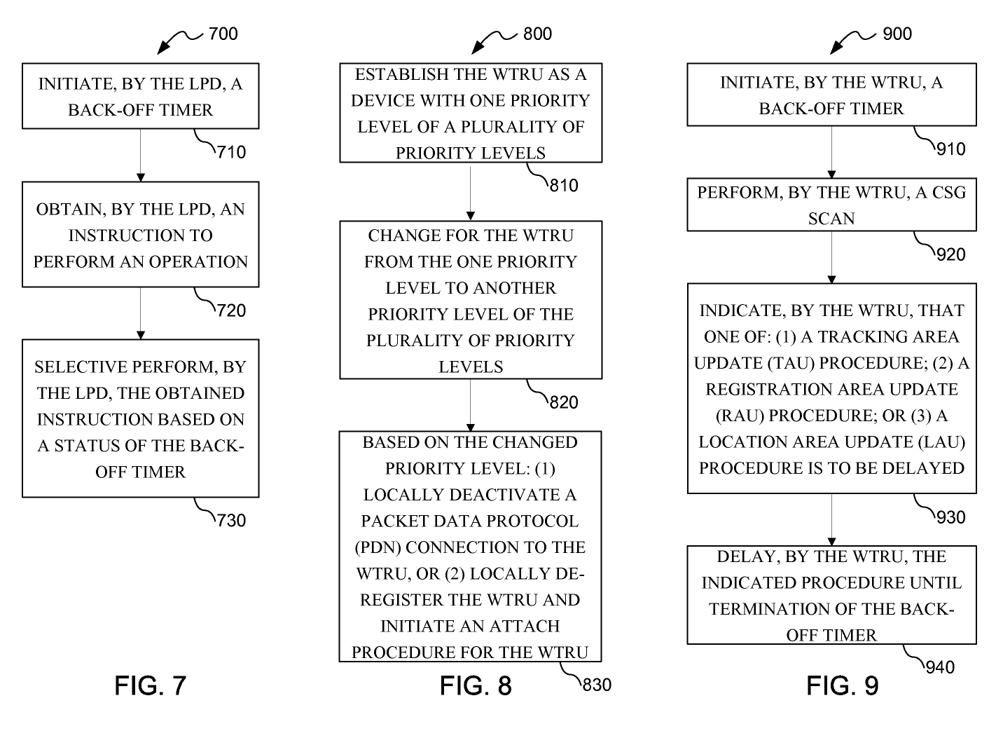

FIG. 7 is a flowchart illustrating a representative method 700.

Referring to FIG. 7, the representative method 700 may manage a WTRU 102 that may be established as a low priority device (LPD). At block 710, the LPD (or WTRU) 102 may initiate a back-off timer. At block 720, the LDP 102 may obtain an instruction to perform an operation and, at block 730, the LPD 102 may selectively perform the obtained instruction (e.g., for a closed subscriber group (CSG) scan) based on a status of the back-off timer. For example, the status of the back-off timer may be running (e.g., executing) or may be expired. In certain embodiments, the LPD 102 may set the back-off timer using parameters (e.g., duration, expiration time, and/or delayed start time for the timer, among others) provided from external sources.

In certain representative embodiments, the LPD or WTRU 102 may receive a back-off parameter and may initiate the back-off timer in accordance with the back-off parameter.

In certain representative embodiments, the LPD or WTRU 102 may present a list of CSG cells that belong to a different public land mobile network (PLMN) or a group of PLMNs in case of gateway core network (GWCN) radio access network (RAN) sharing. The different public land mobile network (PLMN) or the group of PLMNs in case of gateway core network (GWCN) radio access network (RAN) sharing may send the back-off parameter received by the LPD or WTRU 102.

In certain representative embodiments, the LPD or WTRU 102 may determine whether to perform the obtained instruction based on a status of the back-off timer such that the obtained instruction is performed when the back-off timer has expired and the obtained instruction is not performed when the back-off timer has not expired.

In certain representative embodiments, the LPD or WTRU 102 may present a status of the back-off timer.

In certain representative embodiments, the LPD or WTRU 102 may perform the CSG scan even if the back-off timer is running.

In certain representative embodiments, the LPD or WTRU 102 may perform the CSG scan after expiration of the back-off timer and may disregard the instruction to perform a CSG scan during a lifetime of the back-off timer.

In certain representative embodiments, the LPD or WTRU 102 may perform the CSG scan, detect CSG identities in accordance with the performed CSG scan and block a presentation of the detected CSG identities during a blocking period. The blocking period may end after the back-off timer expires or may end immediately prior to a time when the back-off timer is to expire.

In certain representative embodiments, the LPD or WTRU 102 may present an in-progress indication indicating that the CSG scan is in-progress during the performance of the CSG scan.

In certain representative embodiments, the LPD or WTRU 102 may display a list of available CSG cells based on the CSG scan after the blocking period ends.

In certain representative embodiments, the LPD or WTRU 102 may perform the CSG scan, may present a list of CSG cells from the CSG scan for user selection, may disable the user selection of one or more of the CSG cells listed, and may receive the user selection of one of a CSG cell that is not disabled.

In certain representative embodiments, the LPD or WTRU 102 may perform the CSG scan, may present a list of available CSG cells from the CSG scan for user selection, and may receive the user selection of one of the available CSG cells. The available CSG cells may be a subset of the CSG cells identified by performing the CSG scan.

In certain representative embodiments, the LPD or WTRU 102 may disable the user selection during a lifetime (e.g., duration) of the back-off timer.

In certain representative embodiments, the LPD or WTRU 102 may receive the user selection of one of the available CSG cells during a lifetime of the back-off timer.

In certain representative embodiments, the LPD or WTRU 102 may determine whether a condition exists, and may ignore or modify a duration or a status of the back-off timer based on the determined condition. For example, the duration, start time or expiration time may be adjusted based on the mode of operation of the LPD or WTRU 102, the connection state of the LPD or WTRU 102, congestion conditions of the LPD (or, WTRU) 102, one or more CN nodes (such as the MME 142, the MSC 156, and/or the SGSN 158, among others) and/or other conditions such as call status (e.g., emergency/non-emergency status).

FIG. 8 is a flowchart illustrating a representative method 800

Referring to FIG. 8, the representative method 800 may manage a WTRU 102. At block 810, the WTRU 102 or a network entity (NE) may establish the WTRU 102 as a device with one priority level (e.g., a particular priority level of a plurality of priority levels). At block 820, the WTRU 102 or NE may change the one priority level for the WTRU 102 to another priority level (e.g., of the plurality of priority levels).

At block 830, the WTRU 102 based on the changed priority level: (1) may locally deactivate a packet data protocol (PDN) connection to the WTRU 102, and/or (2) may locally de-register the WTRU 102 and initiate an attach procedure for the WTRU 102.

FIG. 9 is a flowchart illustrating a representative method 900

Referring to FIG. 9, the representative method 900 may manage a WTRU 102. At block 910, the WTRU 102 may initiate a back-off timer. At block 920, the WTRU 102 may perform a CSG scan. At block 930, the WTRU 102 may indicate that one of: (1) a tracking area update (TAU) procedure; (2) a registration area update (RAU) procedure; and/or (3) a location area update (LAU) procedure is to be delayed. At block 940, the WTRU 102 may delay the indicated procedure until termination of the back-off timer.

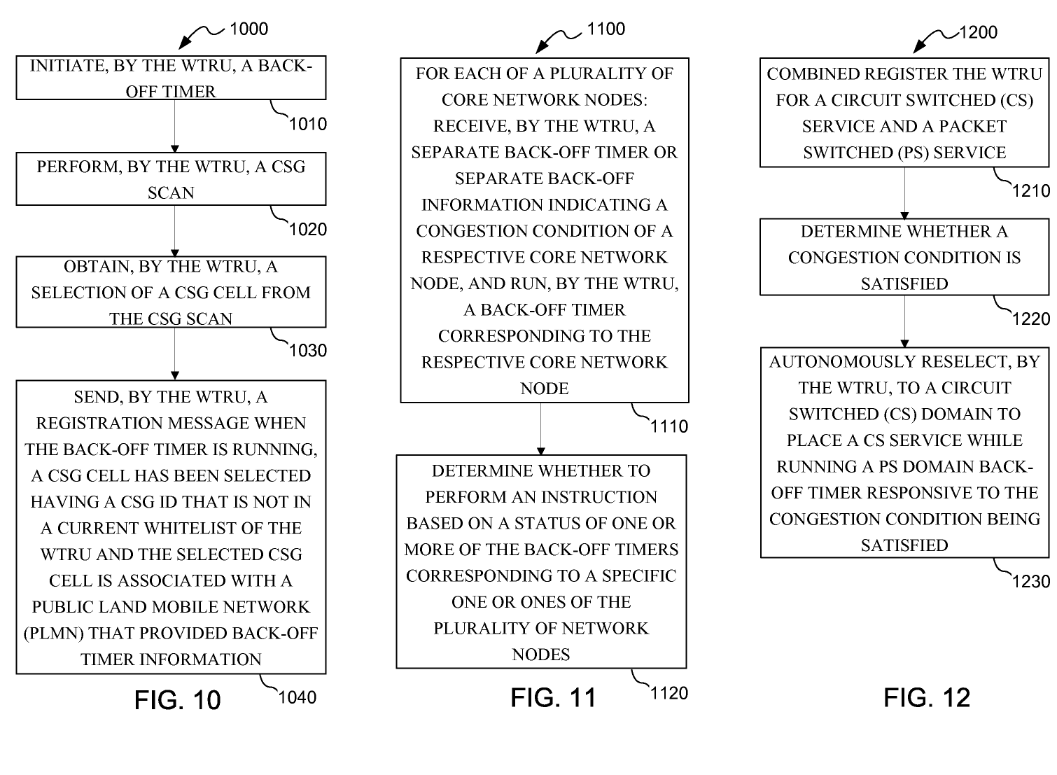

FIG. 10 is a flowchart illustrating a representative method 1000.

Referring to FIG. 10, the representative method 1000 may manage a WTRU 102. At block 1010, the WTRU 102 may initiate a back-off timer. At block 1020, the WTRU 102 may perform a CSG scan. At block 1030, the WTRU 102 may obtain a selection of a CSG cell from the CSG scan. At block 1040, the WTRU 102 may send a registration message when the back-off timer is running, a CSG cell has been selected having a CSG ID that is not in a current whitelist of the WTRU and the selected CSG cell is associated with a public land mobile network (PLMN) that provided back-off timer information.

FIG. 11 is a flowchart illustrating a representative method 1100.

Referring to FIG. 11, the representative method 1100 may manage a WTRU 102. At block 1110, for each of a plurality of CN nodes, (1) the WTRU 102 may receive a separate back-off timer or separate back-off information indicating a congestion condition of a respective CN node, (2) the WTRU 102 may run a back-off timer corresponding to the respective CN node. At block 1120, the WTRU 102 may determine whether to perform an instruction based on a status of one or more of the back-off timers corresponding to a specific one or ones of the plurality of CN nodes.

In certain representative embodiments, the WTRU 102 may obtain the separate back-off timer or back-off information from any of: (1) a MME 142; (2) a MSC/VLR 156; and/or (3) a SGSN 158, among others.

FIG. 12 is a flowchart illustrating a representative method 1200.

Referring to FIG. 12, the representative method 1200 may manage a WTRU 102. At block 1210, the WTRU 102 may combine register the WTRU 102 for a circuit switched (CS) service and a packet switched (PS) service. For example, the WTRU may operate in a first mode (e.g., a NMO 1 mode) in which the WTRU may register with (and/or attach to) an LTE RAN 104A and/or a 3G RAN 104B. At block 1220, the WTRU 102 may determine whether a congestion condition is satisfied. At block 1230, the WTRU 102 may autonomously reselect to a circuit switched (CS) domain to place a CS service while running a PS domain back-off timer responsive to the congestion condition being satisfied. For example, the congestion condition may be whether a mobility management node congestion condition exists (e.g., which may be indicated by the network to the WTRU 102).

In certain representative embodiments, the LPD or WTRU 102 may initiate a tracking area update (TAU) procedure, and may maintain an active CS domain registration after receiving a rejection of the TAU procedure.

In certain representative embodiments, the MME 142 may not inform a MSC/VLR 156 that the WTRU 102 is deregistered with the MME 142.

In certain representative embodiments, the LPD or WTRU 102 may reselect to the CS domain via a radio resource control (RRC) message or an extended service request (ESR) message.

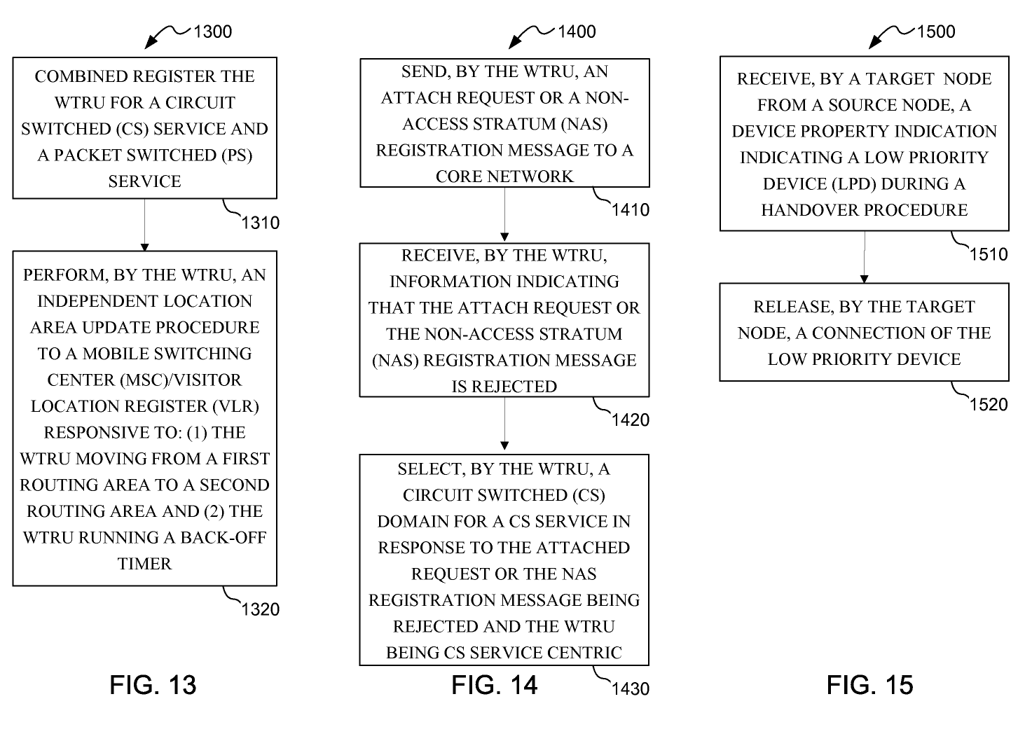

FIG. 13 is a flowchart illustrating a representative method 1300.

Referring to FIG. 13, the representative method 1300 may manage a WTRU 102. At block 1310, the WTRU 102 may combine register the WTRU 102 for a circuit switched (CS) service and a packet switched (PS) service. At block 1320, the WTRU 102 may perform an independent location area update procedure to the MSC/VLR 156 responsive to: (1) the WTRU 102 moving from a first routing area to a second routing area; and (2) the WTRU 102 running a back-off timer.

In certain representative embodiments, the WTRU 102 may perform the independent location area update procedure in lieu of a routing area update procedure.

In certain representative embodiments, the back-off timer run by the WTRU 102 may be a PS back-off timer (e.g., a PS-domain back-off timer) such that the location area update procedure is performed in the CS domain in lieu of performing a routing area update procedure in the PS domain.

In certain representative embodiments, the WTRU 102 may operate using a network mode operation (NMO) 1.

In certain representative embodiments, the WTRU 102 may move between the first and second routing areas that belong to a common location area or that belong to different location areas.

In certain representative embodiments, the WTRU 102 may identify in the independent location update procedure, a SGSN 158 associated with the WTRU 102 is congested using PS domain related parameters.

FIG. 14 is a flowchart illustrating a representative method 1400.

Referring to FIG. 14, the representative method 1400 may handle a WTRU 102. At block 1410, the WTRU 102 may send an attach request or a non-access stratum (NAS) registration message to a core network 106. At block 1420, the WTRU 102 may receive information indicating that the attach request or the non-access stratum (NAS) registration message is rejected. At block 1430, the WTRU may select a circuit switched (CS) domain for a CS service in response to the attached request or the NAS registration message being rejected and the WTRU being CS service centric.

In certain representative embodiments, the WTRU 102 may select the CS domain for a voice call in response to the attached request or the NAS registration message being rejected (e.g., due to a back-off timer and the WTRU being voice-centric).

In certain representative embodiments, the WTRU 102 may select the CS domain for a voice call based on the attached request or the NAS registration being rejected due to back-off.

In certain representative embodiments, the WTRU 102 may determine service capabilities (e.g., support for IP multimedia subsystem (IMS)) supported by the WTRU 102 and may select the CS domain based on the supported service capabilities of the WTRU 102.

In certain representative embodiments, the WTRU 102 may select the CS domain based on the IMS being unsupported by the WTRU 102.

In certain representative embodiments, the WTRU 102 may select the CS domain based on the WTRU preferring an IP multimedia subsystem (IMS) domain for voice calls or the CS domain, as a secondary for voice calls.

In certain representative embodiments, the WTRU 102 may maintain the CS domain selection until the back-off timer expires.

In certain representative embodiments, the WTRU 102 may reestablish long term evolution (LTE) or original settings of the WTRU 102 when an emergency call is placed.

In certain representative embodiments, the WTRU 102 may display an indication indicating that the PS domain is congested responsive to a PS back-off timer running.

In certain representative embodiments, the WTRU 102 may send an ESR to the MME 142 to indicate a circuit switched fallback (CSFB) is to occur in response to a combined attach request for the WTRU 102 being accepted and a PS back-off timer existing for the PS domain.

In certain representative embodiments, the WTRU 102 may include in the ESR an information element or a code-point for the MME 142 not to reject the ESR.

FIG. 15 is a flowchart illustrating a representative method 1500.

Referring to FIG. 15, the representative method 1500 may handle a WTRU 102. At block 1510, a target node may receive from a source node, a device property indication indicating, for example, a low priority device (LPD) during a handover procedure. At block 1520, the target node may release a connection of the LPD.

In certain representative embodiments, the LPD may be indicated by setting a quality of service (QoS) characteristics of bearers of the WTRU 102 to specific values such that a QoS class identifier (QCI) range is defined for LPD bearers.

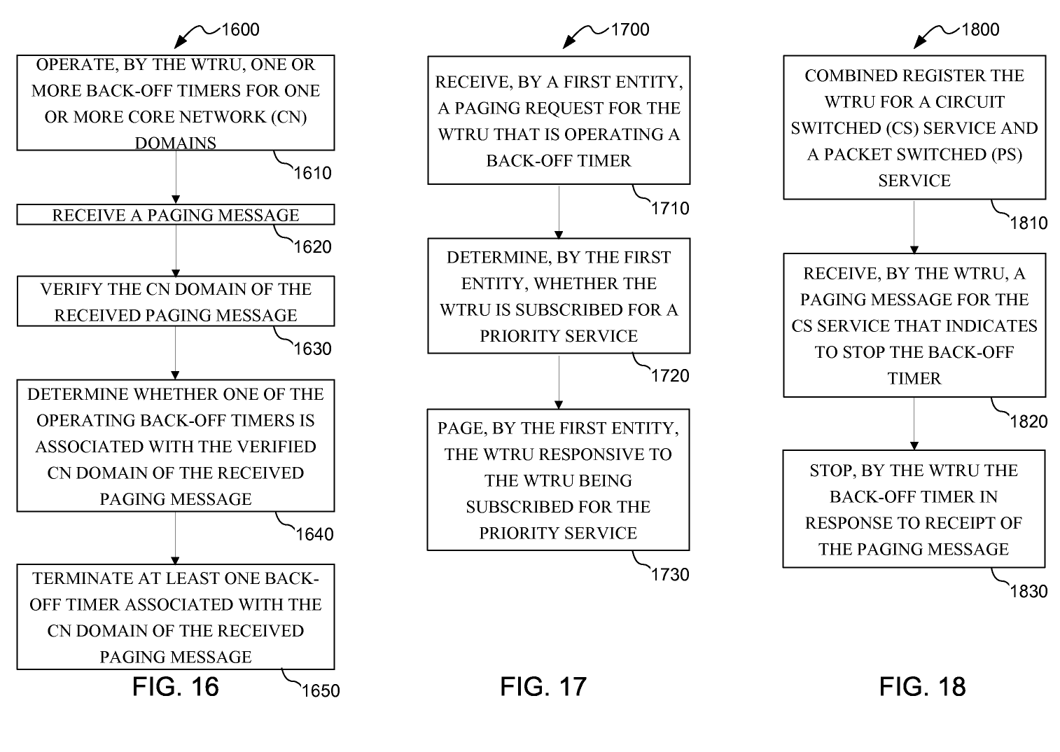

FIG. 16 is a flowchart illustrating a representative method 1600.

Referring to FIG. 16, the representative method 1600 may manage a WTRU 102. At block 1610, a WTRU 102 may operate one or more back-off timers for one or more core network (CN) domains. At block 1620, the WTRU 102 may receive a paging message. At block 1630, the WTRU 102 may verify the CN domain of the received paging message. At block 1640, the WTRU 102 may determine whether one of the operating back-off timers is associated with the verified CN domain of the received paging message. At block 1650, the WTRU 102 may terminate at least one back-off timer associated with the CN domain of the received paging message.

In certain representative embodiments, the WTRU 102 may terminate the operating back-off timers (e.g., all of the operating back-off timers).

FIG. 17 is a flowchart illustrating a representative method 1700.

Referring to FIG. 17, the representative method 1700 may handle a WTRU 102. At block 1710, a first entity 102 may receive a paging request for the WTRU 102 that is operating a back-off timer. At block 1720, the first entity may determine whether the WTRU 102 is subscribed for a priority service. At block 1730, the first entity may page the WTRU 102 responsive to the WTRU 102 being subscribed for the priority service.

In certain representative embodiments, the first entity may determine whether the WTRU 102 is subscribed for an enhanced multimedia priority service (eMPS) or another priority service.

In certain representative embodiments, the first entity may ignore the paging request for the WTRU 102 and may send a paging reject message to a second entity including a cause for the rejection.

In certain representative embodiments, the first entity may send an indication that the WTRU 102 is not reachable.

In certain representative embodiments, the first entity may send one or more indications to one or more core network entities indicating any of: (1) congestion for a particular WTRU 102 or a set of WTRUs 102; (2) the WTRU 102 is in back-off; and/or (3) the WTRU 102 is out of a back-off state.

FIG. 18 is a flowchart illustrating a representative method 1800.

Referring to FIG. 18, the representative method 1800 may handle a WTRU 102. At block 1810, a WTRU 102 may be combined registered for a circuit switched (CS) service and a packet switched (PS) service. At block 1820, the WTRU 102 may receive a paging message for the CS service that may indicate to stop the back-off timer. At block 1830, the WTRU 102 may stop the back-off timer in response to receipt of the paging message.

In certain representative embodiments, the WTRU 102 may receive a PS back-off indication before the WTRU 102 is made to fallback to a CS domain.

In certain representative embodiments, the PS back-off indication may be indicated via one of: an evolved packet system (EPS) mobility management (EMM) Information Request, an EPS session management (ESM) Information Request, a mobility management (MM) Information Request, and/or a GPRS mobility management (GMM) Information Request.

In certain representative embodiments, the WTRU 102 may apply a default back-off timer in response to the back-off indication.

In certain representative embodiments, the WTRU 102 may operate using a plurality of back-off timers, may receive a paging message indicating one of the plurality of operating back-off timers, and may stop the indicated one of the plurality of back-off timers based on the received paging message.

In certain representative embodiments, the WTRU 102 may (1) stop an EPS mobility management (EMM) back-off timer: (i) if a core network (CN) indicator in the paging message includes a first indicator; or (ii) if a paging identity used includes a System Architecture Evolution (SAE) temporary mobile subscriber identity (S-TMSI); and/or (2) stop a CS domain back-off timer if a CN indicator in the paging message includes a second indicator.

In certain representative embodiments, the WTRU 102 may respond to the paging message regardless of a status of the indicated one of the back-off timers.

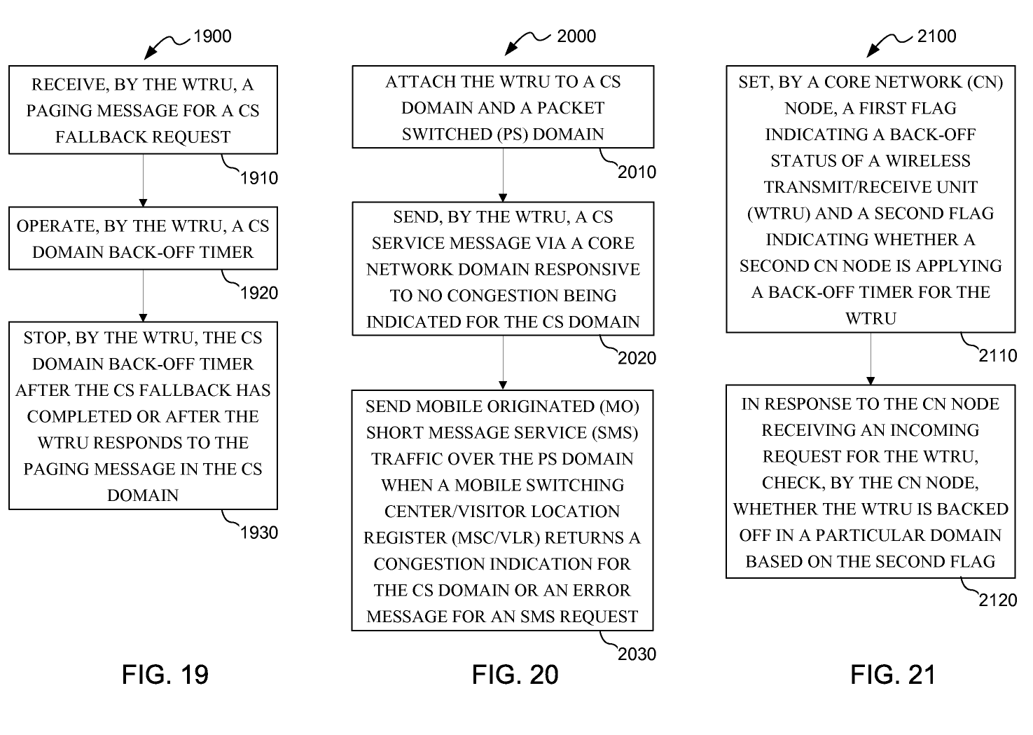

FIG. 19 is a flowchart illustrating a representative method 1900.

Referring to FIG. 19, the representative method 1900 may handle a WTRU 102 and the WTRU 102 may be combined registered for a circuit switched (CS) service and a packet switched (PS) service. At block 1910, the WTRU 102 may receive a paging message for a CS fallback request. At block 1920, the WTRU 102 may operate a CS domain back-off timer. At block 1930, the WTRU 102 may stop the CS domain back-off timer after the CS fallback has completed or after the WTRU 102 responds to the paging message in the CS domain.

In certain representative embodiments, the WTRU 102 may during the operation of the CS domain back-off timer, block sending any messages other than messages for emergency services.

In certain representative embodiments, during the operation of a back-off timer and an emergency bearer service for the WTRU, the WTRU may be called back from an emergency service point.

In certain representative embodiments, the WTRU 102 may stop the CS domain back-off timer responsive to the WTRU 102 receiving a mobile terminated (MT) call short message service (SMS) message.

In certain representative embodiments, the WTRU 102 may stop a T3246 timer, as the CS domain back-off timer responsive to the WTRU receiving a downlink NAS message.

In certain representative embodiments, the WTRU 102 may camp on the PS domain while the CS domain back-off timer is running.

FIG. 20 is a flowchart illustrating a representative method 2000.

Referring to FIG. 20, the representative method 2000 may provide a circuit switched (CS) service using a WTRU 102. At block 2010, the WTRU 102 may be attached to a CS domain and a packet switched (PS) domain. At block 2020, the WTRU 102 may send a CS service message via a CN domain responsive to no congestion being indicated for the CS domain. At block 2030, the WTRU 102 may send mobile originated (MO) short message service (SMS) traffic over the PS domain when a MSC/VLR 156 returns a congestion indication for the CS domain or an error message for an SMS request.

FIG. 21 is a flowchart illustrating a representative method 2100.

Referring to FIG. 21, the representative method 2100 may handle a WTRU 102. At block 2110, a core network (CN) node may set a first flag indicating a back-off status of the WTRU 102 and a second flag indicating whether a second CN node is applying a back-off timer for the WTRU 102. At block 2120, in response to the CN node receiving an incoming request for the WTRU 102, the CN node may check whether the WTRU 102 is backed off in a particular domain based on the second flag.

In certain representative embodiments, in response to the WTRU being backed off in the particular domain (e.g., associated with a second CN node), the CN node may send a request to a third CN node and not send the request to the second CN node.

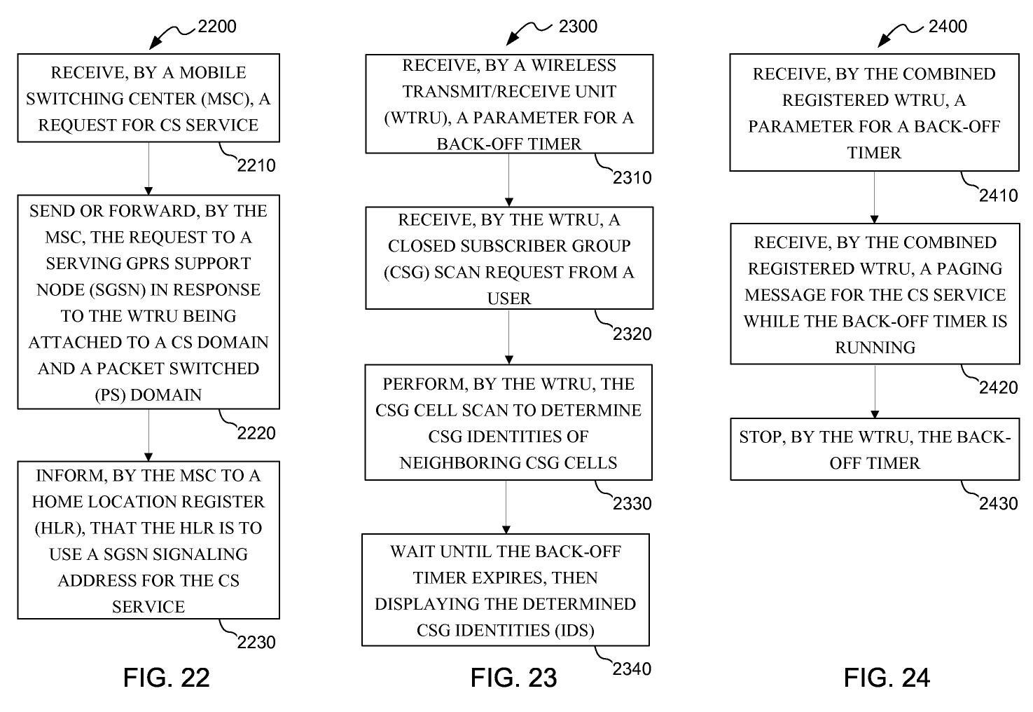

FIG. 22 is a flowchart illustrating a representative method 2200.

Referring to FIG. 22, the representative method 2200 may provide circuit switched (CS) service for a WTRU 102. At block 2210, a MSC 156 may receive a request for CS service.

At block 2220, the MSC 156 may send or may forward the request to a SGSN 158 in response to the WTRU 102 being attached to a CS domain and a packet switched (PS) domain. At block 2230, the MSC may inform a home location register (HLR) that the HLR is to use a SGSN signaling address for the CS service.

In certain representative embodiments, the HLR may receive or obtain an indication that a CN node is applying or is terminating congestion control for the WTRU 102 and forwarding of the request for the CS service to the CN node may be prevented, if the CN node is applying the congestion control.

In certain representative embodiments, the HLR may send information to a server to route the CS service via a node different from the CN node that is applying the congestion control.

FIG. 23 is a flowchart illustrating a representative method 2300.

Referring to FIG. 23, the representative method 2300 may handle a WTRU 102. At block 2310, the WTRU 102 may receive a parameter for a back-off timer;

At block 2320, the WTRU 102 may receive a closed subscriber group (CSG) scan request from a user. At block 2330, the WTRU 102 may perform the CSG cell scan to determine CSG identities of neighboring CSG cells. At block 2340, the WTRU 102 may wait until the back-off timer expires, then display the determined CSG identities (IDs).

FIG. 24 is a flowchart illustrating a representative method 2400.

Referring to FIG. 24, the representative method 2400 may enable access control for a WTRU 102 that is combined registered for a circuit switched (CS) service and a packet switched (PS) service. At block 2410, the WTRU 102 may receive a parameter for a back-off timer. At block 2420, the WTRU 102 may receive a paging message for the CS service while the back-off timer is running At block 2430, the WTRU 102 may stop the back-off timer.

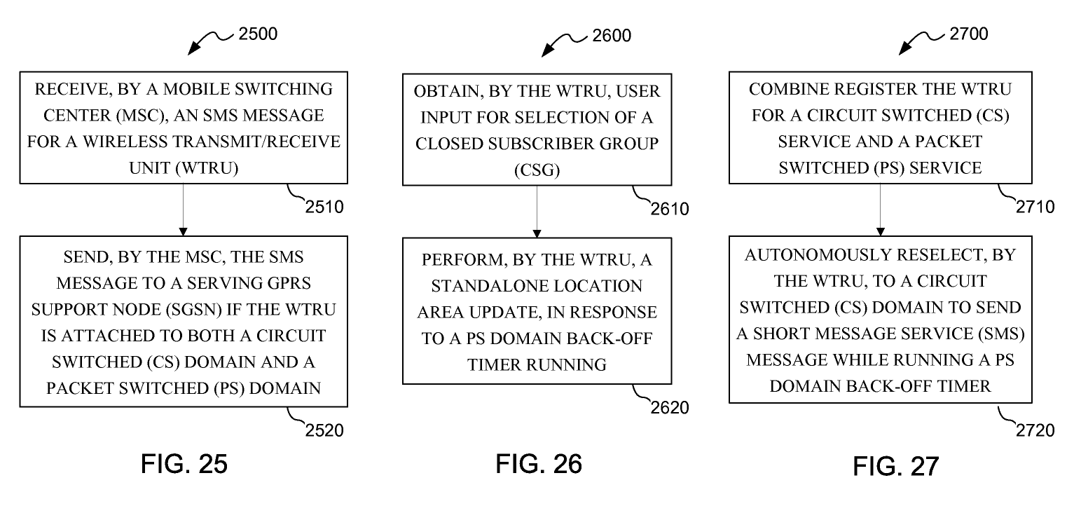

FIG. 25 is a flowchart illustrating a representative method 2500.

Referring to FIG. 25, the representative method 2500 may provide a short message service (SMS). At block 2510, the MSC 156 may receive an SMS message for a WTRU 102.

At block 2520, the MSC 156 may send the SMS message to a serving SGSN 158, if the WTRU 102 is attached to both a circuit switched (CS) domain and a packet switched (PS) domain.

FIG. 26 is a flowchart illustrating a representative method 2600.

Referring to FIG. 26, the representative method 2600 may handle a WTRU 102 operating based on an established network mode of operation (e.g., NMO1) associated with combined registration in both a circuit switched (CS) domain and a packet switched (PS) domain. At block 2610, the WTRU 102 may obtain (e.g., receive or get) user input for selection of a closed subscriber group (CSG). At block 2620, the WTRU 102 may perform a standalone location area update, in response to a PS domain back-off timer, which is running.

In certain representative embodiments, the WTRU 102 may receive a manual CSG selection and may override the established network mode of operation (e.g., NMO1) upon receiving the manual CSG.

In certain representative embodiments, the performance of the standalone location area update may be in lieu of a combined routing area updating procedure associated with both the PS and CS domains.

FIG. 27 is a flowchart illustrating a representative method 2700.

Referring to FIG. 27, the representative method 2700 may handle a WTRU 102.

At block 2710, the WTRU 102 may combine register the WTRU 102 for a circuit switched (CS) service and a packet switched (PS) service. At block 2720, the WTRU 102 may autonomously reselect to a circuit switched (CS) domain to send a short message service (SMS) message while running a PS domain back-off timer.

In certain representative embodiments, the WTRU 102 may determine whether a congestion condition exists and may run the PS domain back-off timer, when the congestion condition exists.

One skilled in the art will understand that the representative embodiments may be used in any combination and/or with any system wherever applicable.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operation or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### Representative Embodiments

In one embodiment, a method of managing a wireless transmit/receive unit (WTRU) having been established as a low priority device (LPD) may comprise: initiating, by the LPD, a back-off timer; obtaining, by the LPD, an instruction to perform an operation; and selective performing, by the LPD, the obtained instruction based on a status of the back-off timer.

In one embodiment, the method may further comprise receiving, by the LPD, a back-off parameter, wherein the initiating of the back-off timer is in accordance with the back-off parameter.

In one embodiment, the method may further comprise presenting, by the LPD, a list of CSG cells that belong to a different public land mobile network (PLMN) or a group of PLMNs in case of gateway core network (GWCN) radio access network (RAN) sharing from which the back-off parameter is received.

In one embodiment, the selective performing of the obtained instruction may include determining whether to perform the obtained instruction based on a status of the back-off timer such that the obtained instruction may be performed when the back-off timer has expired and the obtained instruction may not be performed when the back-off timer has not expired.

In one embodiment, the method may further comprise presenting, by the LPD, a status of the back-off timer.

In one embodiment, the obtaining of the instruction may include obtaining the instruction to perform a closed subscriber group (CSG) scan.

In one embodiment, the method may further comprise performing, by the LPD, the CSG scan even if the back-off timer is running.

In one embodiment, the selective performing of the obtained instruction may include performing, by the LPD, the CSG scan after expiration of the back-off timer; and disregarding, by the LPD, the instruction to perform a CSG scan during a lifetime of the back-off timer.

In one embodiment, the method may further comprise: performing, by the LPD, the CSG scan; detecting CSG identities in accordance with the performed CSG scan; and blocking, by the LPD, a presentation of the detected CSG identities during a blocking period, the blocking period ending after the back-off timer expires or immediately prior to a time when the back-off timer is to expire.

In one embodiment, the method may further comprise presenting, by the LPD, an in-progress indication indicating that the CSG scan is in-progress during the performance of the CSG scan.

In one embodiment, the method may further comprise displaying, by the LPD, a list of available CSG cells based on the CSG scan after the blocking period ends.

In one embodiment, the method may further comprise: performing, by the LPD, the CSG scan; presenting, by the LPD, a list of CSG cells from the CSG scan for user selection; disabling, by the LPD, the user selection of one or more of the CSG cells listed; and receiving, by the LPD, the user selection of one of a CSG cell that is not disabled.

In one embodiment, the method may further comprise performing, by the LPD, the CSG scan; presenting, by the LPD, a list of available CSG cells from the CSG scan for user selection; and receiving, by the LPD, the user selection of one of the available CSG cells, wherein the available CSG cells are a subset of the CSG cells identified by performing the CSG scan.

In one embodiment, the method may further comprise disabling, by the LPD, the user selection during a lifetime of the back-off timer.

In one embodiment, the receiving of the user selection of one of the available CSG cells may occur during a lifetime of the back-off timer.

In one embodiment, the method may further comprise: determining whether a condition exists; and ignoring or modifying a duration or a status of the back-off timer based on the determined condition.

In one embodiment, a method of managing a wireless transmit/receive unit (WTRU may comprise: establishing the WTRU as a device with one priority level of a plurality of priority levels; changing for the WTRU from the one priority level to another priority level of the plurality of priority levels; and based on the changed priority level: (1) locally deactivating a packet data protocol (PDN) connection to the WTRU, or (2) locally de-registering the WTRU and initiating an attach procedure for the WTRU.

In one embodiment, a method of managing a wireless transmit/receive unit (WTRU) may comprise: initiating, by the WTRU, a back-off timer; performing, by the WTRU, a CSG scan; indicating, by the WTRU, that one of: (1) a tracking area update (TAU) procedure; (2) a registration area update (RAU) procedure; or (3) a location area update (LAU) procedure is to be delayed; and delaying, by the WTRU, the indicated procedure until termination of the back-off timer.

In one embodiment, a method of managing a wireless transmit/receive unit (WTRU) may comprise: initiating, by the WTRU, a back-off timer; performing, by the WTRU, a CSG scan; obtaining, by the WTRU, a selection of a CSG cell from the CSG scan; and sending, by the WTRU, a registration message when the back-off timer is running, a CSG cell has been selected having a CSG ID that is not in a current whitelist of the WTRU and the selected CSG cell is associated with a public land mobile network (PLMN) that provided back-off timer information.

In one embodiment, a method of managing a wireless transmit/receive unit (WTRU) may comprise: for each of a plurality of core network nodes: receiving, by the WTRU, a separate back-off timer or separate back-off information indicating a congestion condition of a respective core network node, and running, by the WTRU, a back-off timer corresponding to the respective core network node; and determining whether to perform an instruction based on a status of one or more of the back-off timers corresponding to a specific one or ones of the plurality of core network nodes.

In one embodiment, the receiving of the separate back-off timer or back-off information may include obtaining the separate back-off timer or back-off information from any of: (1) a Mobility Management Entity (MME); (2) a Mobile Switching Center/Visitor Location Register (MSC/VLR); or (3) a Serving General Packet Radio Service (GPRS) Support Node (SGSN).

In one embodiment, a method of managing a wireless transmit/receive unit (WTRU) may comprise: combined registering the WTRU for a circuit switched (CS) service and a packet switched (PS) service; determining whether a congestion condition is satisfied; and autonomously reselecting, by the WTRU, to a circuit switched (CS) domain to place a CS service while running a PS domain back-off timer responsive to the congestion condition being satisfied.

In one embodiment, the determining of whether the congestion condition is satisfied may include determining whether a mobility management node congestion condition exists.

In one embodiment, the method may further comprise: initiating, by the WTRU, a tracking area update (TAU) procedure; and maintaining, by the WTRU, an active CS domain registration after receiving a rejection of the TAU procedure.

In one embodiment, a mobility management entity (MME) may not inform a Mobile Switching Center/Visitor Location Register (MSC/VLR) that the WTRU is deregistered with the MME.

In one embodiment, the autonomously reselecting to the CS domain may include reselecting to the CS domain via a radio resource control (RRC) message or an extended service request (ESR) message.

In one embodiment, a method of managing a wireless transmit/receive unit (WTRU) may comprise: combined registering the WTRU for a circuit switched (CS) service and a packet switched (PS) service; and performing, by the WTRU, an independent location area update procedure to a mobile switching center (MSC)/visitor location register (VLR) responsive to: (1) the WTRU moving from a first routing area to a second routing area and (2) the WTRU running a back-off timer.

In one embodiment, the performing of the independent location area update procedure may be in lieu of a routing area update procedure.

In one embodiment, the back-off timer run by the WTRU may be a PS back-off timer such that the location area update procedure may be performed in a CS domain in lieu of performing a routing area update procedure in a PS domain.

In one embodiment, the method may further comprise operating the WTRU using a network mode of operation (NMO1).

In one embodiment, the method may further comprise moving the WTRU between the first and second routing areas that belong to a common location area or that belong to different location areas.

In one embodiment, the method may further comprise identifying, by the WTRU in the independent location update procedure, a serving GPRS support node (SGSN) associated with the WTRU is congested using PS domain related parameters.

In one embodiment, a method of handling a wireless transmit/receive unit (WTRU) may comprise: sending, by the WTRU, an attach request or a non-access stratum (NAS) registration message to a core network; receiving, by the WTRU, information indicating that the attach request or the non-access stratum (NAS) registration message is rejected; and selecting, by the WTRU, a circuit switched (CS) domain for a CS service in response to the attached request or the NAS registration message being rejected and the WTRU being CS service centric.

In one embodiment, the selecting of the CS domain may be for a voice call in response to the attached request or the NAS registration message being rejected due to a back-off timer and the WTRU being voice-centric.

In one embodiment, the selecting of the CS domain for the CS service in response to the attached request or the NAS registration message being rejected and the WTRU being CS service centric may include selecting the CS domain for a voice call based on the attached request or the NAS registration being rejected due to back-off.

In one embodiment, the method may further comprise determining service capabilities supported by the WTRU, wherein the selecting of the CS domain for the CS service in response to the attached request or the NAS registration message being rejected and the WTRU being CS service centric may include selecting the CS domain based on the supported service capabilities of the WTRU.

In one embodiment, the method may further comprise determining whether IP multimedia subsystem (IMS) is supported by the WTRU; wherein the selecting of the CS domain for the CS service in response to the attached request or the NAS registration message being rejected and the WTRU being CS service centric may include selecting the CS domain based on the IMS being unsupported by the WTRU.

In one embodiment, the selecting of the CS domain for the CS service in response to the attached request or the NAS registration message being rejected and the WTRU being CS service centric may include selecting the CS domain based on the WTRU preferring a IP multimedia subsystem (IMS) domain for voice calls or the CS domain, as a secondary for voice calls.

In one embodiment, the method may further comprise maintaining the CS domain selection until the back-off timer expires.

In one embodiment, the method may further comprise reestablishing, by the WTRU, long term evolution (LTE) or original settings of the WTRU when an emergency call is placed.

In one embodiment, the method may further comprise displaying an indication indicating that the PS domain is congested responsive to a PS back-off timer running.

In one embodiment, the method may further comprise sending an extended service request to a mobility management entity (MME) to indicate a circuit switched fallback (CSFB) is to occur in response to a combined attach request for a the WTRU being accepted and a PS back-off timer existing for the PS domain.

In one embodiment, the method may further comprise including in the extended service request an information element or a code-point for the MME not to reject the extended service request.

In one embodiment, a method for handling low priority devices may comprise: receiving, by a target node from a source node, a device property indication indicating a low priority device (LPD) during a handover procedure; and releasing, by the target node, a connection of the low priority device.

In one embodiment, the method may further comprise indicating the LPD by setting a quality of service (QoS) characteristics of bearers of the WTRU to specific values such that a QoS class identifier (QCI) range is defined for LPD bearers.

In one embodiment, a method of managing a wireless transmit/receive unit (WTRU) may comprise: operating, by the WTRU, one or more back-off timers for one or more core network (CN) domains; receiving a paging message; verifying the CN domain of the received paging message; determining whether one of the operating back-off timers is associated with the verified CN domain of the received paging message; and terminating at least one back-off timer associated with the CN domain of the received paging message.

In one embodiment, the terminating of the at least one back-off timer may include terminating the operating back-off timers.

In one embodiment, a method of handling a wireless transmit/receive unit (WTRU) may comprise: receiving, by a first entity, a paging request for the WTRU that is operating a back-off timer; determining, by the first entity, whether the WTRU is subscribed for a priority service; and paging, by the first entity, the WTRU responsive to the WTRU being subscribed for the priority service.

In one embodiment, the determining whether the WTRU is subscribed for the priority service may include determining whether the WTRU is subscribed for an enhanced multimedia priority service (eMPS) or another priority service.

In one embodiment, the method may further comprise: ignoring, by the first entity, the paging request for the WTRU; and sending, by the first entity, a paging reject message to a second entity including a cause for rejection.

In one embodiment, the sending of the paging reject message may include sending an indication that the WTRU is not reachable.

In one embodiment, the method may further comprise sending, by the first entity, one or more indications to one or more core network entities indicating any of: (1) congestion for a particular WTRU or set of WTRUs; (2) the WTRU is in back-off; or (3) the WTRU is out of a back-off state.

In one embodiment, a method of handling a wireless transmit/receive unit (WTRU) may comprise: combined registering the WTRU for a circuit switched (CS) service and a packet switched (PS) service; receiving, by the WTRU, a paging message for the CS service that indicates to stop the back-off timer; and stopping, by the WTRU the back-off timer in response to receipt of the paging message.

In one embodiment, the method may further comprise receiving, by the WTRU, a PS back-off indication before the WTRU is made to fallback to a CS domain.

In one embodiment, the method may further comprise indicating the PS back-off indication via one of: an evolved packet system (EPS) mobility management (EMM) Information Request, an EPS session management (ESM) Information Request, a mobility management (MM) Information Request, or a GPRS mobility management (GMM) Information Request.

In one embodiment, the method may further comprise applying, by the WTRU, a default back-off timer in response to the back-off indication.

In one embodiment, the method may further comprise: operating, by the WTRU, using a plurality of back-off timers; receiving, by the WTRU, a paging message indicating one of the plurality of operating back-off timers; and stopping, by the WTRU, the indicated one of the plurality of back-off timers based on the received paging message.

In one embodiment, the stopping of the indicated one of the plurality of back-off timers may include: (1) stopping an EPS mobility management (EMM) back-off timer: (i) if a core network (CN) indicator in the paging message includes a first indicator; or (ii) if a paging identity used may include a System Architecture Evolution (SAE) temporary mobile subscriber identity (S-TMSI); and/or (2) stopping a CS domain back-off timer if a CN indicator in the paging message includes a second indicator.

In one embodiment, the method may further comprise responding to the paging message regardless of a status of the indicated one of the back-off timers.

In one embodiment, a method of handling a wireless transmit/receive unit (WTRU) combined registered for a circuit switched (CS) service and a packet switched (PS) service may comprise: receiving, by the WTRU, a paging message for a CS fallback request; operating, by the WTRU, a CS domain back-off timer; and stopping, by the WTRU, the CS domain back-off timer after the CS fallback has completed or after the WTRU responds to the paging message in the CS domain.

In one embodiment, during the operation of the CS domain back-off timer, blocking, by the WTRU, sending any messages other than messages for emergency services.

In one embodiment, during the operation of a back-off timer and an emergency bearer service for the WTRU, calling back the WTRU from an emergency service point.

In one embodiment, the method may further comprise stopping, by the WTRU, the CS domain back-off timer responsive to the WTRU receiving a mobile terminated (MT) call short message service (SMS) message.

In one embodiment, the method may further comprise stopping, by the WTRU, a T3246 timer, as the CS domain back-off timer responsive to the WTRU receiving a downlink NAS message (e.g., signal).

In one embodiment, the method may further comprise camping, by the WTRU, on the PS domain while the CS domain back-off timer is running.

In one embodiment, a method of providing a circuit switched (CS) service using a wireless transmit/receive unit (WTRU) may comprise: attaching the WTRU to a CS domain and a packet switched (PS) domain; sending, by the WTRU, a CS service message via a core network domain responsive to no congestion being indicated for the CS domain; and sending mobile originated (MO) short message service (SMS) traffic over the PS domain when a mobile switching center/visitor location register (MSC/VLR) returns a congestion indication for the CS domain or an error message for an SMS request.

In one embodiment, a method of handling low priority devices may comprise: setting, by a core network (CN) node, a first flag indicating a back-off status of a wireless transmit/receive unit (WTRU) and a second flag indicating whether a second CN node is applying a back-off timer for the WTRU; and in response to the CN node receiving an incoming request for the WTRU, checking, by the CN node, whether the WTRU is backed off in a particular domain based on the second flag.

In one embodiment, the method may further comprise in response to the WTRU being backed off in the particular domain, sending, by the CN node, a request to a third CN node and not send, by the CN node, the request to the second CN node.

In one embodiment, a method of providing circuit switched (CS) service for a wireless transmit/receive unit (WTRU) may comprise: receiving, by a mobile switching center (MSC), a request for CS service; sending or forwarding, by the MSC, the request to a serving GPRS support node (SGSN) in response to the WTRU being attached to a CS domain and a packet switched (PS) domain; and informing, by the MSC to a home location register (HLR), that the HLR is to use a SGSN signaling address for the CS service.

In one embodiment, the method may further comprise: indicating to the HLR that a core network (CN) node is applying or terminating congestion control for the WTRU; and preventing forwarding of the request for the CS service to the CN node if the CN node is applying the congestion control.

In one embodiment, the method may further comprise sending, by the HLR, information to a server to route the CS service via a node different from the CN node that is applying the congestion control.

In one embodiment, a method of handling low priority devices may comprise: receiving, by a wireless transmit/receive unit (WTRU), a parameter for a back-off timer; receiving, by the WTRU, a closed subscriber group (CSG) scan request from a user; performing, by the WTRU, the CSG cell scan to determine CSG identities of neighboring CSG cells, and waiting until the back-off timer expires, then displaying the determined CSG identities (IDs).

In one embodiment, a method for access control for a wireless transmit/receive unit (WTRU) that is combined registered for a circuit switched (CS) service and a packet switched (PS) service may comprise: receiving, by the combined registered WTRU, a parameter for a back-off timer; receiving, by the combined registered WTRU, a paging message for the CS service while the back-off timer is running; and stopping, by the WTRU, the back-off timer.

In one embodiment, a method for providing a short message service (SMS) may comprise: receiving, by a mobile switching center (MSC), an SMS message for a wireless transmit/receive unit (WTRU); and sending, by the MSC, the SMS message to a serving GPRS support node (SGSN) if the WTRU is attached to both a circuit switched (CS) domain and a packet switched (PS) domain.

In one embodiment, a method for handling a wireless transmit/receive unit (WTRU) operating based on an established network mode of operation associated with combined registration in both a circuit switched (CS) domain and a packet switched (PS) domain may comprise: obtaining, by the WTRU, user input for selection of a closed subscriber group (CSG); and performing, by the WTRU, a standalone location area update, in response to a PS domain back-off timer running.

In one embodiment, the obtaining of the user input for selection of a CSG may include receiving a manual CSG selection, wherein the method may further comprise: overriding the established network mode of operation upon receiving the manual CSG selection such that the performing of the standalone location area update is in lieu of a combined routing area updating procedure associated with both the PS and CS domains.

In one embodiment, the established network mode of operation may be network mode of operation 1.

In one embodiment, a method of handling a wireless transmit/receive unit (WTRU) may comprise: combined registering the WTRU for a circuit switched (CS) service and a packet switched (PS) service; and autonomously reselecting, by the WTRU, to a circuit switched (CS) domain to send a short message service (SMS) message while running a PS domain back-off timer.

In one embodiment, the method may further comprise: determining whether a congestion condition exists; and running the PS domain back-off timer, when the congestion condition exists.

In one embodiment, the method may further comprise: providing the SMS message via a CS domain using a Mobility Management Entity (MME).

In one embodiment, a wireless transmit/receive unit (WTRU) configured as a low priority device may comprise: a transmit/receive unit configured to receive a back-off parameter; and

a processor configured to initiate a back-off timer in accordance with the back-off parameter, to determine whether to perform an instruction based on a status of the back-off timer, as a determined result and to selectively perform the instruction based on the determined result.

In one embodiment, the WTRU may further comprise a user interface configured to receive the instruction from a user to perform a closed subscriber group (CSG) scan.

In one embodiment, the processor may be configured to initiate the CSG scan after expiration of the back-off timer.

In one embodiment, the processor may be configured to disregard the instruction to perform the CSG scan during a lifetime of the back-off timer.

In one embodiment, the processor along with the transmit/receive unit may be configured to: perform the CSG scan; detect CSG identities in accordance with the performed CSG scan; block a presentation of the detected CSG identities during a blocking period, the blocking period ending immediately prior to a time when the back-off timer is to expire or when the back-off timer expires; and initiate the presentation of one or more detected CSG identifiers after the blocking period ends.

In one embodiment, the WTRU may further comprise a presentation unit configured to present a status of the back-off timer including an in-progress indication indicating that the CSG scan is being performed.

In one embodiment, the processor may be configured to perform the CSG scan even if the back-off timer is running.

In one embodiment, the WTRU may further comprise a presentation unit configured to present a list of CSG cells that belong to a different public land mobile network (PLMN) or group of PLMNs in case of gateway core network (GWCN) radio access network (RAN) sharing from which the back-off timer or back-off information is received.

In one embodiment, the WTRU may further comprise a display unit configured to display a list of available CSG cells based on the CSG scan.

In one embodiment, the WTRU may further comprise: a display unit configured to present a list of CSG cells, a first subset of the CSG cells listed being disabled such that a selection, by a user of the disabled CSG cells, is disabled and a second subset of the CSG cells listed being enabled such that the selection, by the user of the enabled CSG cells, is enabled; and a user interface configured to receive the user selection of one of a CSG cell that is enabled.

In one embodiment, the WTRU may further comprise: a display unit configured to present a list of available CSG cells for user selection; and an input unit configured to receive the user selection of one of the available CSG cells, wherein the available CSG cells are a subset of the CSG cells identified by performing the CSG scan.

In one embodiment, the processor may be configured to disable the user selection during a lifetime of the back-off timer.

In one embodiment, the processor may be configured to: determine whether a condition exists; and ignore or modify a duration or a status of the back-off timer based on the determined condition.

In one embodiment, a wireless transmit/receive unit (WTRU) may comprise: a processor configured to: initiate a back-off timer, perform a CSG scan; indicate that one of: (1) a tracking area update (TAU) procedure; (2) a registration area update (RAU) procedure; or (3) a location area update (LAU) procedure is to be delayed; and delay the indicated procedure until termination of the back-off timer.

In one embodiment, a wireless transmit/receive unit (WTRU) may comprise: a processor configured to: initiate a back-off timer; perform a CSG scan; and obtain a selection of a CSG cell from the CSG scan; and a transmit/receive unit configured to: send a registration message when the back-off timer is running, a CSG cell has been selected having a CSG ID that is not in a current whitelist of the WTRU and the selected CSG cell is associated with a public land mobile network (PLMN) that provided back-off timer information.

In one embodiment, a wireless transmit/receive unit (WTRU) may comprise: a transmit/receive unit configured to, for each of a plurality of core network nodes, receive a separate back-off timer or separate back-off information indicating a congestion condition of a respective core network node, and a processor configured to: (1) for each of a plurality of core network nodes run a back-off timer corresponding to the respective core network node; and (2) determine whether to perform an instruction based on a status of one or more of the back-off timers corresponding to a specific one or ones of the plurality of core network nodes.

In one embodiment, a wireless transmit/receive unit (WTRU) established as a device with one priority level of a plurality of priority levels may comprise: a processor and transmit/receive unit configured to: change the WTRU from the one priority level to another priority level of the plurality of priority levels; and based on the changed priority level: locally deactivate a packet data protocol (PDN) connection to the WTRU, or locally de-register the WTRU and initiate an attach procedure for the WTRU.

In one embodiment, a wireless transmit/receive unit (WTRU) may comprise: a processor and transmit/receive unit configured to: combined register the WTRU for a circuit switched (CS) service and a packet switched (PS) service; determine whether a congestion condition is satisfied; and autonomously reselect to a circuit switched (CS) domain to place a CS service while running a PS domain back-off timer responsive to the congestion condition being satisfied.

In one embodiment, the processor may be configured to: determine whether a mobility management condition exists; and reselect to the CS domain via a radio resource control (RRC) message or an extended service request (ESR) message.

In one embodiment, the transmit/receive unit may be configured to: receive, prior to the processor determining whether the congestion condition is satisfied, an indication of congestion from a plurality of core network nodes including a Mobility Management Entity (MME), a Mobile Switching Center/Visitor Location Register (MSC/VLR), a Serving General Packet Radio Service (GPRS) Support Node (SGSN) or any combination thereof.

In one embodiment a wireless transmit/receive unit (WTRU) may comprise: a processor and transmit/receive unit configured to: combine register the WTRU for a circuit switched (CS) service and a packet switched (PS) service; and perform an independent location area update procedure to a mobile switching center (MSC)/visitor location register (VLR) responsive to: (1) the WTRU moving from a first routing area to a second routing area and (2) the WTRU running a back-off timer.

In one embodiment, the processor may be configured to perform the independent location area update procedure in lieu of a routing area update procedure.

In one embodiment, the processor may be configured to operate using a network mode of operation (NMO1).

In one embodiment, the processor may be configured to identify in the independent location update procedure a serving GPRS support node (SGSN) associated with the WTRU is congested using PS domain related parameters.

In one embodiment, a wireless transmit/receive unit (WTRU) may comprise: a processor and transmit/receive unit configured to: send an attach request or a non-access stratum (NAS) registration message to a core network; receive information indicating that the attach request or the non-access stratum (NAS) registration message is rejected; and select a circuit switched (CS) domain for a CS service in response to the attached request or the NAS registration message being rejected and the WTRU being CS service centric.

In one embodiment, the processor may be configured to select a voice call in response to the attached request or the NAS registration message being rejected due to a back-off timer and the WTRU being voice-centric.

In one embodiment, the processor may be configured to determine service capabilities supported by the WTRU, and select the CS domain based on the supported service capabilities of the WTRU.

In one embodiment, the processor may be configured to determine whether IP multimedia subsystem (IMS) is unsupported by the WTRU; and select the CS domain based on the IMS being unsupported by the WTRU.

In one embodiment, the processor may be configured to select the CS domain based on the WTRU preferring an IP multimedia subsystem (IMS) domain for voice calls or the CS domain, as a secondary for voice calls.

In one embodiment, the processor may be configured to maintain the CS domain selection until the back-off timer expires.

In one embodiment, the processor may be configured to reestablish long term evolution (LTE) or original settings of the WTRU when an emergency call is placed.

In one embodiment, the method may further comprise a display unit configured to display an indication indicating that the PS domain is congested responsive to a PS back-off timer running.

In one embodiment, the transmit/receive unit may be configured to send an extended service request to a mobility management entity (MME) to indicate a circuit switched fallback (CSFB) is to occur in response to a combined attach request for a the WTRU being accepted and a PS back-off timer existing for the PS domain.

In one embodiment, a core network node may comprise a processor and transmit/receive unit configured to: receive from a second node, a device property indication indicating a low priority device (LPD) is being handed over during a handover procedure; and release a connection of the low priority device.

In one embodiment, a network node may comprise: a processor and transmit/receive unit configured to: receive a paging request for the WTRU that is operating a back-off timer; determine whether the WTRU is subscribed for a priority service; and page the WTRU responsive to the WTRU being subscribed for the priority service.

In one embodiment, the processor may be configured to determine whether the WTRU is subscribed for an enhanced multimedia priority service (eMPS) or another priority service.

In one embodiment, the processor may be configured to ignore the paging request for the WTRU; and the transmit/receive unit may be configured to send a paging reject message to another network node including a cause for rejection.

In one embodiment, the transmit/receive unit may be configured to send an indication that the WTRU is not reachable.

In one embodiment, the transmit/receive unit may be configured to send one or more indications to one or more core network entities indicating any of: (1) congestion for a particular WTRU or set of WTRUs; (2) the WTRU is in back-off; or (3) the WTRU is out of a back-off state.

In one embodiment, a wireless transmit/receive unit (WTRU) may comprise: a processor and transmit/receive unit configured to: combine register the WTRU for a circuit switched (CS) service and a packet switched (PS) service; receive a paging message for the CS service that indicates to stop the back-off timer; and stop the back-off timer in response to receipt of the paging message.

In one embodiment, the transmit/receive unit may be configured to receive a PS back-off indication before the WTRU is made to fallback to a CS domain.

In one embodiment, the processor may be configured to indicate the PS back-off indication via one of: an evolved packet system (EPS) mobility management (EMM) Information Request, an EPS session management (ESM) Information Request, a mobility management (MM) Information Request, or a GPRS mobility management (GMM) Information Request.

In one embodiment, the processor may be configured to apply a default back-off timer in response to the back-off indication.

In one embodiment, the processor may be configured to operate using a plurality of back-off timers; and the transmit/receive unit may be configured to receive a paging message indicating one of the plurality of operating back-off timers such that the processor stop the indicated one of the plurality of back-off timers based on the received paging message.

In one embodiment, a wireless transmit/receive unit (WTRU) combine registered for a circuit switched (CS) service and a packet switched (PS) service may comprise: a processor and transmit/receive unit configured to: receive a paging message for a CS fallback request; operate a CS domain back-off timer; and stop the CS domain back-off timer after the CS fallback has completed or after the WTRU responds to the paging message in the CS domain.

In one embodiment, the processor may be configured to: during the operation of the CS domain back-off timer, block sending any messages other than messages for emergency services.

In one embodiment, the processor may be configured to stop the CS domain back-off timer responsive to the WTRU receiving a mobile terminated (MT) call short message service (SMS) message.

In one embodiment, the processor may be configured to stop a T3246 timer, as the CS domain back-off timer responsive to the WTRU receiving a downlink NAS message.

In one embodiment, the WTRU may be configured to camp on the PS domain while the CS domain back-off timer is running.

In one embodiment, a wireless transmit/receive unit (WTRU) may comprise: a processor and transmit/receive unit configured to: attach the WTRU to a CS domain and a packet switched (PS) domain; send a CS service message via a core network domain responsive to no congestion being indicated for the CS domain; and send mobile originated (MO) short message service (SMS) traffic over the PS domain when a mobile switching center/visitor location register (MSC/VLR) returns a congestion indication for the CS domain or an error message for an SMS request.

In one embodiment, a core network (CN) node may comprise: a processor and transmit/receive unit configured to: set a first flag indicating a back-off status of a wireless transmit/receive unit (WTRU) and a second flag indicating whether a second CN node is applying a back-off timer for the WTRU; and in response to the CN node receiving an incoming request for the WTRU, check whether the WTRU is backed off in a particular domain based on the second flag.

In one embodiment, the transmit/receive unit may be configured to, in response to the WTRU being backed off in the particular domain, send a request to a third CN node and not send the request to a second CN node.

In one embodiment, a wireless transmit/receive unit (WTRU) may comprise: a processor and transmit/receive unit configured to: receive a parameter for a back-off timer; receive a closed subscriber group (CSG) scan request from a user; and perform the CSG cell scan to determine CSG identities of neighboring CSG cells, and wait until the back-off timer expires, then display the determined CSG identities (IDs).

In one embodiment, a wireless transmit/receive unit (WTRU) that is combined registered for a circuit switched (CS) service and a packet switched (PS) service may comprise: a processor and transmit/receive unit configured to: receive a parameter for a back-off timer; receive a paging message for the CS service while the back-off timer is running; and stop the back-off timer.

In one embodiment, a mobile switching center (MSC) for providing a short message service (SMS) message may comprise: a processor and transmit/receive unit configured to: receive an SMS message for a wireless transmit/receive unit (WTRU); and send the SMS message to a serving GPRS support node (SGSN) if the WTRU is attached to both a circuit switched (CS) domain and a packet switched (PS) domain.

In one embodiment, a wireless transmit/receive unit (WTRU) may comprise: a transmit/receive unit configured to receive a paging message; and a processor configured to operate one or more back-off timers for one or more core network (CN) domains, verify the CN domain of the received paging message; determine whether one of the operating back-off timer is associated with the verified CN domain of the received paging message, and terminate at least one back-off timer associated with the CN domain of the received paging message.

In one embodiment, the processor may be configured to terminate the operating back-off timers.

In one embodiment, the transmit/receive unit may be configured to receive a back-off indication before the WTRU is made to fallback to a CS domain.

In one embodiment, the processor may be configured to apply a default back-off timer in response to a back-off indication.

In one embodiment, the transmit/receive unit may be configured to receive the paging message that indicate one of the plurality of operating back-off timers; and the processor may be configured to: operate using a plurality of back-off timers, and stop the indicated one of the plurality of back-off timers based on the received paging message.

In one embodiment, the processor may be configured to: stop an EPS mobility management (EMM) back-off timer: (1) if a core network (CN) indicator in the paging message may include a first indicator; or (2) if a paging identity used may include a System Architecture Evolution (SAE) temporary mobile subscriber identity (S-TMSI); and stop a CS domain back-off timer, if a CN indicator in the paging message may include a second indicator.

In one embodiment, the processor may be configured to respond to the paging message regardless of a status of the indicated one of the back-off timers.

In one embodiment, the transmit/receive unit may be configured to receive a page for a circuit switched (CS) fallback request; and the processor may be configured to: operate a CS domain back-off timer, and stop the back-off timer after the CS fallback has completed or after the WTRU responds to the paging message in the CS domain.

In one embodiment, during operation of the CS domain back-off timer, the transmit/receive unit may be configured to not send any messages other than messages for emergency services.

In one embodiment, the processor may be configured to stop a circuit switched (CS) back-off timer responsive to the WTRU receiving a mobile terminated (MT) short message service (SMS) message.

In one embodiment, a mobile switching center (MSC) for providing circuit switched (CS) service for a wireless transmit/receive unit (WTRU) may comprise: a processor and transmit/receive unit configured to: receive a request for CS service; send or forward the request to a serving GPRS support node (SGSN) in response to the WTRU being attached to a CS domain and a packet switched (PS) domain; and inform a home location register (HLR), that the HLR is to use a SGSN signaling address for the CS service.

In one embodiment, the processor may be configured to: indicate to the HLR that a core network (CN) node is applying or terminating congestion control for the WTRU; and prevent forwarding of the request for the CS service to the CN node if the CN node is applying the congestion control.

In one embodiment, the transmit/receive unit may be configured to send information to a server to route the CS service via a node different from the CN node that is applying the congestion control.

In one embodiment, a wireless transmit/receive unit (WTRU) configured to operate based on an established network mode operation associated with combined registration in both a circuit switched (CS) domain and a packet switched (PS) domain may comprise: an interface device, a transmit/receive unit and a processor configured to: obtain user input for selection of a closed subscriber group (CSG); and perform a standalone location area update, in response to a PS domain back-off timer running.

In one embodiment, the interface device may be configured to receive a manual CSG selection; and the processor may be configured to override the established network mode operation upon receiving the manual CSG selection such that the standalone location area update is performed using the transmit/receive unit in lieu of a combined routing area updating procedure.

In one embodiment, a wireless transmit/receive unit (WTRU) configured to combine register in both a circuit switched (CS) domain and a packet switched (PS) domain may comprise: a transmit/receive unit and a processor configured to determine whether a PS domain back-off timer is running; and autonomously reselect to a circuit switched (CS) domain to send a short message service (SMS) message while a PS domain back-off timer is running.

What is claimed is:

1. A method of managing a wireless transmit/receive unit (WTRU), the method comprising:
combined registering the WTRU for a circuit switched (CS) service and a packet switched (PS) service; and
performing, by the WTRU, an independent location area update procedure to a mobile switching center (MSC)/visitor location register (VLR) responsive to: (1) the WTRU moving from a first routing area to a second routing area and (2) the WTRU running a back-off timer.

2. The method of claim 1, wherein the performing of the independent location area update procedure is in lieu of a routing area update procedure.

3. The method of claim 1, wherein the back-off timer run by the WTRU is a PS back-off timer such that the location area update procedure is performed in a CS domain in lieu of performing a routing area update procedure in a PS domain.

4. The method of claim 1, further comprising operating the WTRU using a network mode operation (NMO) 1.

5. The method of claim 1, further comprising moving the WTRU between the first and second routing areas that belong to a common location area or that belong to different location areas.

6. The method of claim 1, further comprising identifying, by the WTRU in the independent location update procedure, a serving GPRS support node (SGSN) associated with the WTRU is congested using PS domain related parameters.

7. A method of handling a wireless transmit/receive unit (WTRU) combined registered for a circuit switched (CS) service and a packet switched (PS) service, the method comprising:
receiving, by the WTRU, a paging message for a CS fallback request;
operating, by the WTRU, a CS domain back-off timer; and
stopping, by the WTRU, the CS domain back-off timer after the CS fallback has completed or after the WTRU responds to the paging message in the CS domain.

8. The method of claim 7, wherein during the operation of the CS domain back-off timer, blocking, by the WTRU, sending any messages other than messages for emergency services.

9. The method of claim 7, wherein during the operation of a back-off timer and an emergency bearer service for the WTRU, calling back the WTRU from an emergency service point.

10. The method of claim 7, further comprising:
stopping, by the WTRU, the CS domain back-off timer responsive to the WTRU receiving a mobile terminated (MT) call short message service (SMS) message.

11. The method of claim 7, further comprising:
stopping, by the WTRU, a T3246 timer, as the CS domain back-off timer responsive to the WTRU receiving a downlink NAS message

12. The method of claim 7, further comprising:
camping, by the WTRU, on the PS domain while the CS domain back-off timer is running.

13. A method for handling a wireless transmit/receive unit (WTRU) operating based on an established network mode of operation associated with combined registration in both a circuit switched (CS) domain and a packet switched (PS) domain, the method comprising:
obtaining, by the WTRU, user input for selection of a closed subscriber group (CSG); and
performing, by the WTRU, a standalone location area update, in response to a PS domain back-off timer running.

14. The method of claim 13, wherein the obtaining of the user input for selection of the CSG includes receiving a manual CSG selection, the method further comprising:
overriding the established network mode of operation upon receiving the manual CSG selection such that the performing of the standalone location area update is in lieu of a combined routing area updating procedure associated with both the PS and CS domains.

15. The method of claim 13, wherein the established network mode of operation is network mode of operation 1.

16. A wireless transmit/receive unit (WTRU), comprising:
a processor and transmit/receive unit configured to:
combined register the WTRU for a circuit switched (CS) service and a packet switched (PS) service; and
perform an independent location area update procedure to a mobile switching center (MSC)/visitor location register (VLR) responsive to: (1) the WTRU moving from a first routing area to a second routing area and (2) the WTRU running a back-off timer.

17. The WTRU of claim 16, wherein the processor is configured to perform the independent location area update procedure in lieu of a routing area update procedure.

18. The WTRU of claim 16, wherein the processor is configured to operate using a network mode operation (NMO) 1.

19. The WTRU of claim 16, the processor is configured to identify in the independent location update procedure a serving GPRS support node (SGSN) associated with the WTRU is congested using PS domain related parameters.

20. A wireless transmit/receive unit (WTRU) combined registered for a circuit switched (CS) service and a packet switched (PS) service, comprising:
a processor and transmit/receive unit configured to:
receive a paging message for a CS fallback request;
operate a CS domain back-off timer; and
stop the CS domain back-off timer after the CS fallback has completed or after the WTRU responds to the paging message in the CS domain.

21. The WTRU of claim 20, wherein the processor is configured to:
during the operation of the CS domain back-off timer, block sending any messages other than messages for emergency services.

22. The WTRU of claim 20, wherein the processor is configured to stop the CS domain back-off timer responsive to the WTRU receiving a mobile terminated (MT) call short message service (SMS) message.

23. The WTRU of claim 20, wherein the processor is configured to stop a T3246 timer, as the CS domain back-off timer responsive to the WTRU receiving a downlink NAS message

24. The WTRU of claim 20, wherein the WTRU is configured to camp on the PS domain while the CS domain back-off timer is running.

25. A wireless transmit/receive unit (WTRU) configured to operate based on an established network mode of operation associated with combined registration in both a circuit switched (CS) domain and a packet switched (PS) domain, comprising:
an interface device, a transmit/receive unit and a processor configured to:
obtain user input for selection of a closed subscriber group (CSG); and
perform a standalone location area update, in response to a PS domain back-off timer running.

26. The WTRU of claim 25, wherein:
the interface device is configured to receive a manual CSG selection; and
the processor is configured to override the established network mode of operation upon receiving the manual CSG selection such that the standalone location area update is performed using the transmit/receive unit in lieu of a combined routing area updating procedure.
